(19) United States
(12) Patent Application Publication
(10) Pub. No.: US 2026/0099786 A1
(43) Pub. Date: Apr. 9, 2026

(54) SYSTEMS AND METHODS FOR DYNAMIC RESOURCE MANAGEMENT

(71) Applicants: Allan Arthur John Malcomson, Richmond (CA); Elizabeth Miriam Ruth Malcomson, Manotick (CA)

(72) Inventors: Allan Arthur John Malcomson, Richmond (CA); Elizabeth Miriam Ruth Malcomson, Manotick (CA)

(21) Appl. No.: 18/906,637

(22) Filed: Oct. 4, 2024

(51) Int. Cl. G06Q 10/0631

(52) U.S. Cl. CPC G06Q 10/06315; G06Q 10/06316

(57) ABSTRACT

The present disclosure provides methods, systems, and apparatus for dynamically managing and allocating resources within an organization to meet varying workplace demands. The method includes receiving a request with a Required Response Profile (RRP) and determining one or more primary resources to handle the request. If the primary resources are unavailable, an alternative resource is automatically identified and assigned based on factors such as skill level, department, role, proximity, and current availability. The system may enable real-time resource allocation and efficient task management by dynamically reassigning tasks, even when primary resources are engaged with lower-priority tasks. This approach may optimize resource utilization and improves response times across different organizational settings.

### FIELD OF THE INVENTION

The present invention pertains to resource management, and in particular to methods, systems and apparatus related for dynamically managing and allocating resources in response to varying workplace demands and requirements.

### BACKGROUND

Effective resource management is crucial for maintaining operational efficiency across various industries. Traditional systems often rely on static allocation methods, assigning tasks based on predetermined schedules or fixed criteria. While adequate for basic operations, these systems struggle to adapt to the dynamic and unpredictable nature of real-world environments. For instance, when unexpected spikes in demand occur or resources become unavailable, these systems may fail to reallocate tasks efficiently, leading to delays, reduced productivity, and diminished customer satisfaction.

Additionally, manual intervention is frequently required to address resource shortages or reassign tasks, a process that is both time-consuming and prone to errors. Existing systems generally lack robust mechanisms for tracking resource performance and providing feedback based on task outcomes, limiting opportunities for optimization and continuous improvement. Moreover, these traditional approaches often face challenges related to scalability, particularly in large or rapidly growing organizations where the volume and complexity of tasks can overwhelm static systems. The inability to predict future resource needs and adjust allocations accordingly further exacerbates these issues.

Therefore, there is a need for methods, systems and apparatus for dynamically managing and allocating resources, that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

The disclosure may provide for methods, systems and apparatus for dynamically managing and allocating resources in response to varying workplace demands and requirements. According to an aspect, a method is provided for dynamically managing resources at an organization. The method includes receiving a request for assistance. The request includes a required response profile indicating one or more requirements for responding to the request. The method further includes determining one or more primary resources of the organization for responding to the request based on the required response profile. The method further includes, upon determining that the one or more primary resources are unavailable to respond to the request, automatically identifying, based on the required response profile, an alternative resource within the organization to respond to the request. The method further includes sending the request to the alternative resource. The method further includes receiving, from the alternative resource, a response indicating acceptance of the request.

In some embodiments, each primary resource of the one or more primary resources indicates an unavailable status. In some embodiments, the one or more primary resources of the organization for responding to the request are determined in real-time. In some embodiments, the alternative resource is determined in real time.

In some embodiments, each primary resource of the one or more primary resources is assigned as a primary resource to respond to the request based on the required response profile and a resource profile of said each primary resource. In some embodiments, the alternative resource indicates an available status and is assigned as the alternative resource to respond to the request based on the required response profile and a resource profile of the alternative resource.

In some embodiments, the one or more requirements for responding to the request indicate a required skill level. In some embodiments, the resource profile of said each primary resource indicates the required skill level. In some embodiments, the resource profile of the alternative resource indicates the required skill level.

In some embodiments, the one or more requirements for responding to the request indicate a department of the organization associated with the request. In some embodiments, the resource profile of said each primary resource indicates the department as a primary department. In some embodiments, the resource profile of the alternative resource indicates the department as an alternative department.

In some embodiments, the alternative resource is identified further based on one or more of: a role within the organization, proximity to a location of the request, relevant skills, number of similar requests handled, cost of the alternative resource, a response time, performance, and resource type.

In some embodiments, the method further includes determining a set of available resources of the organization, wherein each resource of the set of available resources indicates an available status, and wherein the alternative resource is automatically identified from the set of available resources. For example, if the primary resources are unavailable, instead of force assigning the request to another already engaged primary resource, a secondary “available” resource is automatically selected instead.

In some embodiments, the request further indicates a first priority level. In some embodiments, the method further includes establishing the first priority level based on the required response profile (RRP). In some embodiments, the alternative resource indicates an engaged status associated with a second request, the second request indicating a second priority level lower than the first priority level.

In some embodiments, the alternative resource is a primary resource of the one or more primary resources. In some embodiments, the further includes determining a set of engaged resources of the organization, wherein each resource of the set of engaged resources indicates an engaged status, and wherein the alternative resource is identified from the set of engaged resources. For example, where primary resources are unavailable and a primary resource is unavailable due to being engaged with a task of a lower priority than the received request, then, the primary resource is automatically selected for responding to the request (i.e., force assigned to take on the request). In some embodiments, the engaged status of the alternative resource is self-declared.

In some embodiments, each resource of the set of engaged resources further indicates an unavailable status in addition to the engaged status. In some embodiments, the method further includes upon receiving the response indicating acceptance of the request, automatically identifying, based on the second request, a second alternative resource within the organization to respond to the second request. In some embodiments, the method further includes sending, to the second alternative resource, the second request. In some embodiments, the method further includes receiving, from the second alternative resource, a second response indicating acceptance of the second request.

In some embodiments, the method further includes receiving one or more outcomes of the request from the alternative resource. In some embodiments, the method further includes sending an instruction to the alternative resource. The instruction may provide guidance to the alternative resource in responding to the request, the instruction being based on the request and a resource profile of the alternative resource. In some embodiments, the one or more outcomes of the request include a feedback associated with instruction, the feedback indicating a usefulness of the instruction in responding to the request.

According to one aspect, an apparatus may be provided, where the apparatus includes: a memory, configured to store a program; a processor, configured to execute the program stored in the memory, and when the program stored in the memory is executed, the processor is configured to perform one or more of the methods and systems described herein.

According to another aspect, a computer readable medium may be provided, where the computer readable medium stores program code executed by a device and the program code is used to perform one or more of the methods and systems described herein.

According to one aspect, a chip may be provided, where the chip includes a processor and a data interface, and the processor reads, by using the data interface, an instruction stored in a memory, to perform one or more of the methods and systems described herein. Aspects may further include the memory. Additionally or alternatively, the chip may include electronics hardware such as digital circuits, analog circuits, or a combination thereof, which are configured to implement the operations as described herein.

Other aspects of the disclosure provide for apparatus, and systems configured to implement the methods according to the first aspect disclosed herein. For example, wireless stations and access points can be configured with machine readable memory containing instructions, which when executed by the processors of these devices, configures the device to perform one or more of the methods and systems described herein.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 illustrates a required response profile (RRP), according to an embodiment.

FIG. 2A illustrates a workflow for escalating a request to an appropriate resources in real-time, according to an embodiment.

FIG. 2B illustrates current activity and knowledge profile factors, according to an embodiment.

FIG. 3 illustrates multiple levels of resources, according to an embodiment.

FIG. 4 illustrates deployment of a tip card, according to an embodiment.

FIG. 5 illustrate a framework for real-time monitoring and management of resources, according to an embodiment.

FIG. 6A illustrates a flowchart for initial request handling and engagement process, according to an embodiment.

FIG. 6B illustrates a flowchart for request types and engagement initiation, according to an embodiment.

FIG. 6C illustrates a flowchart for multi-level resource allocation and priority establishment, according to an embodiment.

FIG. 6D illustrates a flowchart for monitoring and escalation during resource engagement, according to an embodiment.

FIG. 6E illustrates a flowchart for handling extended engagements and notifications, according to an embodiment.

FIG. 6F illustrates a flowchart for outcome selection and detailed reporting, according to an embodiment.

FIG. 7 illustrates a network architecture for implementing a resource management system (RMS), according to an embodiment.

FIG. 8 illustrates a method for managing resources, according to an embodiment.

FIG. 9 illustrates is a schematic diagram of an electronic device that may perform any or all of operations of the above methods and features explicitly or implicitly described herein, according to different embodiments of the present application.

It will be noted that throughout the appended drawings, like features are identified by like reference numerals.

### DETAILED DESCRIPTION

Embodiments of the present disclosure provide for apparatus, methods and systems for dynamically managing and allocating resources in response to varying workplace demands and requirements. According to an aspect, a method is provided for dynamically managing resources at an organization. The method includes receiving a request for assistance. The request may be triggered by a customer or a resource requesting assistance. The request includes a required response profile indicating one or more requirements for responding to the request. The method further includes determining one or more primary resources of the organization for responding to the request based on the required response profile. The method further includes, upon determining that the one or more primary resources are unavailable to respond to the request, automatically identifying, based on the required response profile, an alternative resource within the organization to respond to the request. The method further includes sending the request to the alternative resource. The method further includes receiving, from the alternative resource, a response indicating acceptance of the request.

Embodiments may enable workforces to effectively deploy their resources (e.g., personnel) through unique response structures assigned to each request. In some embodiments, a request is triggered through a physical medium or through an application (e.g., a mobile application).

Embodiments are based on one or more of: required response profiles, dynamic status monitoring through proactive and reactive engagements, hierarchy of deployment and escalation or progression models. Embodiments may further enable a systematic and logical response to one more requests (e.g., requests for assistance). Embodiments may allow for dynamic allocation or reallocation of resources based on one or more received requests.

Embodiments may allow for a scalable approach that may be suitable for various industries such as retail, health and wellness, hospitality, manufacturing, and more. This may be achieved through customization, where request components are designed to be modular. For instance, in the retail industry, customization might involve setting specific protocols for customer assistance and hazard alerts. In contrast, in the hospitality industry, customization might involve prioritizing room service requests and guest comfort.

In some embodiments, customizable elements include one or more of: request details, request requirements, hierarchical response levels, personnel roles, training or skill requirements, notification frequency, location (e.g., isle, department or collection of departments), response levels, arrival expectations, engagement length expectations, tip cards (as described herein), priority, response protocols, etc.

In some embodiments, a resource (e.g., a personnel, a robot, a workstation, etc.) is deployed based on a conversion rate. For instance, if one personnel member has a higher conversion rate in a specific area compared to another, embodiments can prioritize deploying the more successful salesperson to that area. In some embodiments, sales conversion data and customer traffic load may be used to create training opportunities. For example, during low customer load, a training opportunity may be suggested by assigning high-converting and low-converting personnel to the same area allowing for observation and learning. This approach may not only enhance sales performance but also foster continuous personnel development.

According to an embodiment, a request can be programmed or configured to have a required response profile (RRP). According to an embodiment, when a request is initiated, active resources (which may be dynamic which includes available and engaged resources) are compared with the RRP of the request. In some embodiments, the RRP includes one or more factors or requirements that facilitate in determining the appropriate resource to respond to the request or call.

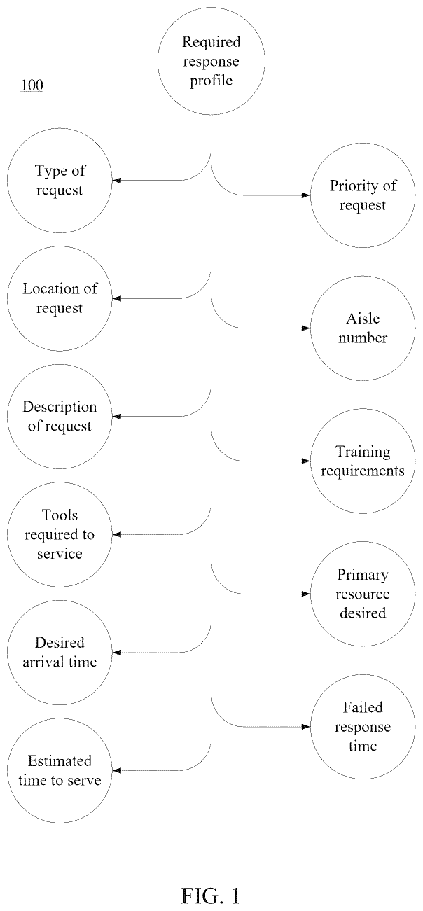

FIG. 1 illustrates an RRP, according to an embodiment. The RRP 100 is a framework that includes one or more requirements, factors or indicators that are used to evaluate and determine a suitable resource to respond to the request. The one or more requirements may include: a type of request (determined based on its nature or purpose), a location of the request where the request is initiated (e.g., an identifier of one or more of: a department, a zone, a section), an aisle number, a description of the request (offering context and specific details that may affect how the request is handled, such as customer needs or special conditions), a primary resource desired to respond (a preferred resource expected to respond at a first level of resources), a priority or criticality level of the request, a training requirement or level indicating necessary skills and training needed to respond effectively, a tool or equipment needed to complete the task, a desired arrival time (an optimal time frame within which the resource should arrive), a failed response time (a threshold after which the response is considered late or failed), and estimated time to serve, among other requirements.

In some embodiments, the RRP is used in decision-making to match requests with resources by analyzing these factors, ensuring that a qualified and available resource is deployed to meet the needs of each request. This systematic approach may improve resource utilization and enhances the overall effectiveness of the response.

According to an embodiment, upon receiving a request, resources are allocated or reallocated dynamically in real-time to respond effectively. Thus, embodiments may facilitate the dynamic adjustment of resource allocation in response to changing demands.

According to an embodiment, responding to a request may include assessing the RRP (e.g., one or more requirements) against a dynamic pool of resources available to respond. One or more factors based on the RRP and the profiles of the resources may be considered to determine an appropriate resource to respond to the request. In some embodiments, the one or more factors include a resource's status or a status of the resources. The resource's status may indicate one or more of: a current activity, an online status, an offline status, an available status, an engaged status, being on break (e.g., a meal break), and other indicators of status and/or activity. In some embodiments, the one or more factors further includes a priority of the request. The priority of the request may be used to determine how the request ranks relative to the resource's other priorities (corresponding to one or more other requests associated with the resource). In some embodiments, the priority of the request is compared with one or more priorities of one or more requests currently being served by one or more resources.

In some embodiments, the one or more factors further include a proximity of the resource to the location of the request. In some embodiments, the one or more factors further include a current activity of the resource. In some embodiments, the priority of the request is compared to a priority of a current activity of the resource, where the priority of the current activity may be based on a priority of a request or task that is currently being served or engaged by the resource. In some embodiments, the one or more factors further include a training or skill level of the resource, which may be compared with the required training level of the request. In some embodiments, the one or more factors further include a response history including responses to similar requests. In some embodiments, the one or more factors further include other relevant dynamic or changing factors that may influence the suitability of a resource for the request. Embodiments may consider the one or more factors, in real-time, to determine an appropriate resource to respond to the request, which may improve response time and resource utilization.

Embodiments may enable a resource to proactively indicate when the resource is actively engaged with a customer, task or a request. This ability may be referred to as the “Scout” feature. In a retail setting, for example, when a resource approaches a customer and asks, “Hi, can I help you?” and the customer responds affirmatively, the resource can immediately update their status to reflect this engagement. Unlike existing systems that track resource engagement only when a request is generated through a reactive channel, embodiments may provide a more comprehensive view of resource availability by capturing both proactive and reactive engagements. By allowing resources to log their proactive engagements, embodiments may provide an improved understanding of the true availability and workload of resources. This enhanced visibility may enable resources to manage their time and tasks more effectively, leading to improved customer service and operational efficiency.

Embodiments may enable real-time dynamic allocation of resources in response to changing demands. For example, consider a scenario where Sarah, a store employee which can be considered a resource, is assisting a customer with a product inquiry in the electronics section. Sarah's current activity may be assigned a priority of 3 based on the nature of the task (assisting a customer with a product inquiry) and the department (electronics). Simultaneously, an emergency occurs where a child is injured in the store. An emergency situation may be considered a high priority, e.g., Priority 1. Upon recognizing the emergency, embodiments may assess the status and role of available resources to determine which resources need to be notified. The emergency may trigger a request with a corresponding RRP, which may indicate a required skill level to handle the emergency situation. According to an embodiment, available resources may be determined. The available resources may be determined to include Jon, who is currently available to respond to requests. However, Jon's profile indicates that Jon lacks the required skill level to respond to the emergency request. Provided that the Sarah's profile indicates that Sarah has the required skill level to respond to the emergency request and based on one or more factors of Sarah's profile and the RRP, Sarah is determined to be the appropriate resource to respond to the request. The one or more factors may include: priority of the request (priority 1 for the emergency request), priority of the current activity (priority 3), proximity of Sarah to the emergency location, response history. Embodiments may then issue an alert to Sarah, informing Sarah of the high-priority situation requiring her attention.

According to an embodiment, Sarah's current task is dynamically evaluated against the new emergency based on the relevant factors (RRP factors and Sarah's profile). Embodiments may promptly initiate the reallocation process, assigning another resource, Jon, to cover Sarah's task in the electronics section. The alert that Sarah receives includes detailed instructions, notifying her that Jon is on his way to assist the customer and directing her to proceed immediately to the emergency location.

This dynamic reallocation may ensure that both the customer assistance and the emergency are handled efficiently. John's timely arrival allows for continuous customer support, while Sarah's prompt response to the emergency ensures immediate attention to the critical situation. This demonstrates one example of embodiments'capability to optimize staff deployment and maintain high service levels even in emergency scenarios.

In some embodiments, priority of a request is preconfigured when configuring the request. In some embodiments, priority of a request is established automatically when triggered. Upon deploying a request (e.g., a request is received), embodiments may consider all other active requests and position the new request appropriately based on its hierarchical importance. In some embodiments, this process is applied to every active resource, displaying their respective requests in priority sequence. Embodiments may allow for managing multiple requests dynamically based on priority of the requests.

For example, consider a busy Saturday at a big-box retailer where several situations arise: two customers press buttons (where these buttons can be configured as such) to request help at the same time—one for a high-value item and another for a low-value item (customer requests); a suspicious customer is spotted in the workplace (theft alert); the workplace is running low on shopping carts (customer task); and a hazard arises when a customer spills muriatic acid (hazard alert). According to an embodiment, each request may be assigned a priority based on one or more priority factors or criteria including: urgency (e.g., how quickly the request needs to be addressed), impact (e.g., the potential consequences of not addressing the request promptly), resource availability (e.g., availability of qualified resources to handle the request), location proximity (e.g., how close the resource is to the request location), and current workload: (the current workload of the resource).

According to an embodiment, each priority factor or criterion may be given a weight based on its importance in determining the priority. The weights add up to 100%, and they can be adjusted based on the specific needs of the organization. For example, urgency: 40%, impact: 30%, resource availability: 15%, location proximity: 10%, and current workload: 5%. Each priority factor is further scored on a scale (e.g., 1 to 5). Higher scores may represent a higher priority or importance for that priority factor. An example for scoring the priority factor urgency may be as follows: 5=life-threatening or critical emergency; 4=high-impact but not life-threatening; 3=important but not urgent, 2=routine task with some importance; and 1=low-priority task with no immediate impact. Accordingly, a total priority score may be determined or calculated for each request. The total priority score may be determined based on multiplying the score for each priority factor by its weight and sum the results to obtain a total score. The request is then ranked based on its total score, the higher the score, the higher the priority. In some embodiments, the priority score is preconfigured when configuring the request, and upon receiving the request, the priority score can be ranked among active requests. In some embodiments, the priority score can be adjusted or recalculated based on the priority factors.

According to an embodiment, when a request is received or configuring the request (e.g., in case of pre-configuration), it is evaluated against a set of factors (e.g., urgency, impact, resource availability, location proximity, current workload, etc.). Each factor is assigned a score, and these scores are weighted and summed to produce a total priority score for the request. All requests are ranked in order of their total priority scores. Requests may then be managed in the order of their priority scores, with the highest-scoring requests addressed first.

Embodiments may ensure that each request is assigned to an appropriate resource according to a priority order, thereby enhancing response efficiency and safety. The hierarchical structure may be dynamically maintained by continuously assessing the resource profiles including availability and skill levels among other factors (which may be dynamic or static). As requests are generated and resources are deployed, the system may adjust the hierarchy in real-time. This dynamic adjustment may improve response times and overall efficiency.

According to an embodiment, a resource profile may be generated and continuously updated for each resource to facilitate the matching of requests with appropriate resources. The resource profile may include one or more attributes or characteristics. In some embodiments, the resource profile indicates a resource type, which may identify the category or classification of the resource (e.g., full-time employee, part-time employee, contractor, etc.). In some embodiments, the resource profile may further indicate whether the resource is a human resource or a non-human resource (e.g., a machine, robot, and AI-based system). In some embodiments, the resource profile may further indicate a role, which may define the role, function, position or responsibility of the resource within the organization (e.g., sales associate, manager, technician, maintenance robot, etc.). In some embodiments, the role indicator may indicate an authorization level associated with one or more of: section, department, access doors, and the like. In some embodiments, the resource profile may further indicate a response time, which indicates an average or expected response time of the resource. In some embodiments, the response time includes timeframes for different categories (e.g., defined by priority) of requests. In some embodiments, the resource profile may further indicate a response history, which maintains a record of the resource's previous responses to various types of requests, detailing the success rate, time taken, and any other relevant metrics for each type of request.

In some embodiments, the resource profile may further indicate a performance metric, which may include historical performance data, such as efficiency in handling previous requests, customer satisfaction ratings, outcomes, and other relevant performance indicators. In some embodiments, the resource profile may further indicate an area of responsibility, which defines the area or zone within the organization for which the resource is responsible (e.g., specific aisles in a store, particular floors in a building, etc.). In some embodiments, the resource profile may further indicate a primary department, which identifies the main department or area of responsibility to which the resource is assigned (e.g., electronics, customer service, health and safety, etc.). In some embodiments, the resource profile may further indicate a one or more secondary or alternative departments, which identifies an additional department(s) or area where the resource may also be assigned to work if needed. In some embodiments the areas of responsibility may be based on one or more of: a primary department and the secondary department(s).

In some embodiments, the resource profile may further indicate a shift length, which details the duration of the resource's work shift, including start and end times. For non-human resources, the shift length may include operational periods or maintenance schedules. In some embodiments, the resource profile may further indicate one or more upcoming shifts, which provides information on the resource's scheduled future shifts, enabling better planning and allocation of resources.

In some embodiments, the resource profile may further indicate a status, which describes the current operational status or state of the resource, which may include indications such as available, busy or engaged, on break, offline, under maintenance, etc. In some embodiments, the resource profile may further indicate a current activity, which may specify the resource's present activity or task (e.g., assisting a customer, restocking shelves, on a call, etc.). In some embodiments, the current activity may be linked or associated with the status, and one or both of the current activity and the status may be linked or associated with a request.

In some embodiments, the resource profile may further indicate a knowledge profile. The knowledge profile may indicate a training or skill level, which may outline the resource's qualifications, training, certifications, and skill levels pertinent to the types of requests they may need to handle. The knowledge profile may further indicate a level of experience the resource has. The knowledge profile may further indicate one or more tools and equipment that the resource may have access to. In some embodiments, the resource profile may further indicate a priority adjustment capability, which indicate the resource's capacity to handle different priority levels, including their ability to escalate or de-escalate requests based on real-time assessments. In some embodiments, for non-human resources, capability factor may include technical specifications, operational limits, and task compatibility (e.g., the types of tasks a robot or AI system is capable of performing). In some embodiments, the resource profile may further indicate an interaction preference, which may specify how the resource interacts with other resources or the environment, which may be relevant for AI and robotic systems that may have specific communication protocols or environmental requirements.

According to an embodiment, the resource profile may further indicate a cost associated with each resource. This cost may be defined as a reflection of the resource's overall value or impact within the organization, which may be expressed in monetary units, time, resource allocation, or another relevant metric. The cost may represent factors such as the hourly rate of a human resource, the operational cost of a non-human resource (e.g., maintenance and energy consumption for a machine or robot), or the relative value of the resource based on its contribution to the organization (e.g., sales performance, customer satisfaction, or critical role). In some embodiments, the cost may also factor in the potential impact on other operations if the resource is reallocated to respond to a request, thereby considering opportunity costs. For example, a highly specialized technician may have a higher cost due to their expertise and the impact of pulling them away from their primary tasks.

The resource profile may be used to dynamically match resources to incoming requests based on the required response profile (RRP), optimizing the overall efficiency and responsiveness of the organization.

According to an embodiment, for each request, one or more resources may be categorized into different levels based on the RRP and the resource profiles to determine an appropriate resource to respond to the request. Each allocated resource may be classified into one or more levels, e.g., primary, secondary, tertiary, quaternary, etc. for responding to the request. The classification into levels may be dynamic and adaptable to the context of the request. The classification into levels may be based on one or more attributes of the resource profiles and one or more factors indicated by the RRP.

According to an embodiment, a resource is classified as primary if the corresponding resource profile indicates as primary department the department indicated by the RRP. Similarly, a resource may be classified as secondary if the corresponding resource profile indicates as secondary or alternative department the department indicated by the RRP.

According to an embodiment, resources may be categorized into different levels based on their role and responsibility within the organization. For example, primary resources may include those trained or assigned to manage certain types of requests as their primary function. Secondary resources may include those who have the necessary skills but are not primarily responsible for the request type. In some embodiments, a resource having a particular department or zone (which may be based on multiple departments) as a primary department and having a non-manager role at said particular department or zone may be a primary resource for a request having a location at said particular department or zone. A resource having the particular department or zone as a primary department but having a manager role at said particular department may be considered as a secondary or a tertiary resource for the request. Similarly, a resource having the particular department or zone has a secondary or alternative department may be considered a secondary or tertiary resource for the request.

In some embodiments, the categorization of resources into levels may be based on their skill and qualification relative to the request. For instance, resources with specialized training or certifications directly relevant to the request (as indicated by the RRP) may be classified as primary resources. Secondary and tertiary levels may include those with general or related skills that can assist but are not specialized for the request.

According to an embodiment, resources may be categorized based on their proximity to the request location and their availability. Proximity can be a relevant factor in time-sensitive requests, where nearby resources are prioritized. If primary resources are unavailable due to distance or engagement, secondary resources closer to the request may be notified via dynamic escalation as described herein.

In some embodiments, the performance history of resources, as recorded in the resource profile, may be used to categorize them into levels. Primary resources may include those with a high success rate and efficiency in handling similar requests. Secondary resources may include those with moderate performance metrics, while tertiary resources may include those with less experience or mixed performance.

According to an embodiment, the current status and activity of a resource may influence their classification. Primary resources may be those currently available and not engaged in any other task. If a resource is engaged in a lower-priority task, they may still be considered as a primary or secondary resource if their skills align with the request.

In some embodiments, resources may be categorized into levels based on their type (e.g., human, machine, robot, AI-based system). Primary resources may include human personnel for tasks requiring human judgment or interaction, while secondary or tertiary resources may include machines or AI systems capable of handling routine or technical tasks. The classification may also depend on the task's complexity and the resource type's compatibility.

According to an embodiment, resources may be classified into levels based on their frequency of historical response to similar requests. Resources with a higher frequency of handling similar requests may be categorized as primary, while those with less frequent response histories may be categorized into lower levels. In some embodiments, resources may be classified based on their capability to adjust priorities. Resources that can dynamically escalate or de-escalate tasks based on real-time assessments may be categorized as higher-level resources, capable of handling critical tasks that require immediate attention and decision-making.

According to an embodiment, resources may be classified into different levels based on their associated cost in relation to the request's RRP and the organization. For example, a primary level may include high-cost resources, such as specialized personnel or advanced AI systems, that are critical for high-priority or complex requests. A secondary level may include mid-cost resources that offer a balance between cost and effectiveness, suitable for medium-priority requests. A tertiary level may encompass lower-cost resources, such as part-time staff or simpler automated systems, appropriate for lower-priority or routine requests.

For instance, in responding to a high-priority request that requires specialized skills, a high-cost expert resource may be classified as a primary resource due to their ability to address the request with minimal risk and maximum efficiency. In contrast, for a lower-priority request, a lower-cost resource may be classified as primary, reserving higher-cost resources for more critical tasks. This cost-based classification allows the system to optimize resource allocation by balancing the financial impact with the urgency and complexity of the request.

As may be appreciated, resources may be classified or categorized in any manner deemed appropriate, based on one or more factors from the RRP and resource profile. The classification of resources is not limited to any particular approach or methodology. Instead, it may vary depending on the nature of the request, the factors associated with the request, and the corresponding characteristics of the resources. This flexibility may allow the system to adapt to various scenarios and organizational needs, ensuring that resources are allocated efficiently and effectively in response to requests, regardless of the classification method employed. As such, embodiments may provide a flexible and context-sensitive approach to resource classification, ensuring that requests are matched with appropriate resources based on a comprehensive evaluation of factors within the RRP and resource profile. This classification into multiple levels may allow for more granular and improved resource allocation, thereby improving response efficiency across a wide range of scenarios.

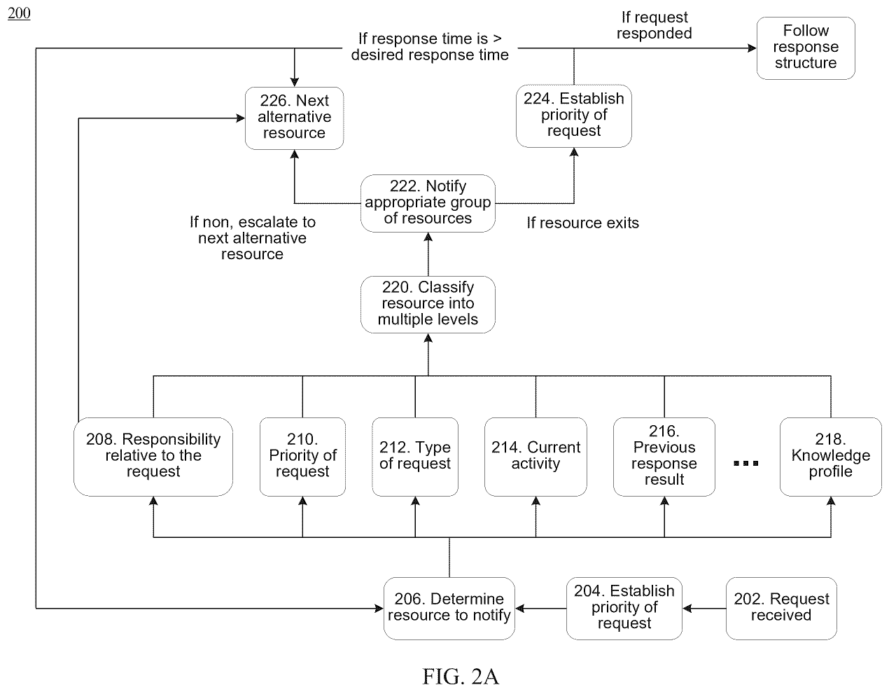

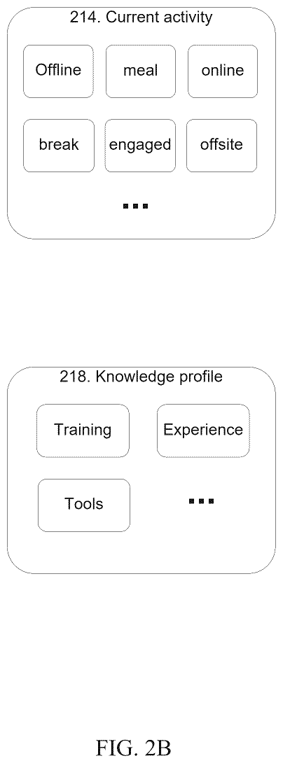

FIG. 2A illustrates a workflow for escalating a request to an appropriate resource in real-time, according to an embodiment. In some embodiments, the workflow 200 is used to manage how requests are addressed and escalated.

In some embodiments, when a request is received 202, a corresponding priority is established 204 based on one or more factors according to embodiments described herein. Based on the request and established priority, an appropriate resource is determined 206. Determining the appropriate resource involves considering one or more factors based on the RRP and resource profiles of the resources. The one or more factors include responsibility of a resource relative to the request 208, priority of the request 210, type of request 212, current activity 214 of a resource, previous response result 216 of the resource (e.g., historical data regarding past performance on similar request), profile knowledge 218 of the resource and other relevant factors based on RRP and resource profiles. Referring to FIG. 2B, which illustrates current activity and knowledge profile factors, the current activity 214 may further indicate a status of the resource which may be one or more of: offline, on meal, online or available, on break, engaged, offsite, etc. Similarly, the knowledge profile 218 may further indicate one or more of: a training level of a resource, experience of the resource, tool or equipment that the resource may have access to, and other relevant information of the resource. Referring back to FIG. 2A, upon considering one or more factors, the resources are then classified 220 into multiple levels as described according to embodiments herein. Thereafter, an appropriate group of resources, e.g., one or more primary resources, is notified 222 to respond to the request.

In some embodiments, where the response time is more than a desired response time, or no primary resources are available to respond, then the request is escalated to an alternative resource 226. In some embodiments, the alternative resource may be a resource at a secondary or alternative level as classified 220. In some embodiments, the alternative resource may be a primary resource that is unavailable but engaged with another less priority task. In some embodiments, the alternative resource is determined 206 based on the one or more factors of RRP and resource profiles.

After determining and notifying an appropriate resource (whether a primary resource or an alternative resource), a corresponding priority is established 224 and the request may be responded to and monitored according to a embodiments described herein. In some embodiments, establishing priority 224 may involve establishing where in a user's list (e.g., a resource's list of requests, which may be ranked accordingly to priority) the request should appear. For example, in some cases, an organization (e.g., a store) may assign equal priority to all buttons, meaning that the first customer to press a button will receive service first. In other cases, the store may designate certain locations as higher priority, so if a customer at one of these locations presses a button—even after another customer—their request will take precedence and appear higher in the list.

According to an embodiment, a request is escalated statically or dynamically. The escalation may occur across different resource levels or within a same resource level, depending on the availability and suitability of resources. When a request is received, resources are classified into hierarchical response levels (referring to classifying resources into different levels) based on their responsibility and suitability to respond to a request. According to an embodiment, resources classified at a primary level are initially allocated a predetermined time to respond to the request. If the request is not responded to within this predetermined time, the request may escalate to a secondary level of resources, in a process referred to as static escalation.

In some embodiments, if no primary level resources are available to respond to the request, for example, all primary-level resources are currently engaged with other requests or tasks, the request may dynamically (e.g., automatically in real-time) progress to the next level of resources (e.g., secondary level of resources) without waiting for the predetermined time to lapse, in a process referred to as dynamic progression. This dynamic progression allows for real-time reallocation of resources, ensuring that the request is addressed promptly, even if primary resources are unavailable.

This process of dynamic progression or static escalation continues across the assigned hierarchical levels within the organization until an appropriate resource is identified and allocated to respond to the request.

The combination of dynamic and static models may enhance response times by efficiently escalating or progressing requests based on resource profiles and the RRP. Understanding resource capabilities and availability across different levels may improve resource utilization and streamline the transmission of notifications.

Dynamic or automatic progression of requests may result in quick and efficient responses, potentially leading to higher customer satisfaction and improved service quality, as requests are promptly addressed by appropriate resources. Additionally, the hierarchical response levels may support scalability and adaptability across various industries, such as retail, healthcare, and beyond, by enabling the customization of response levels and protocols to meet specific operational needs.

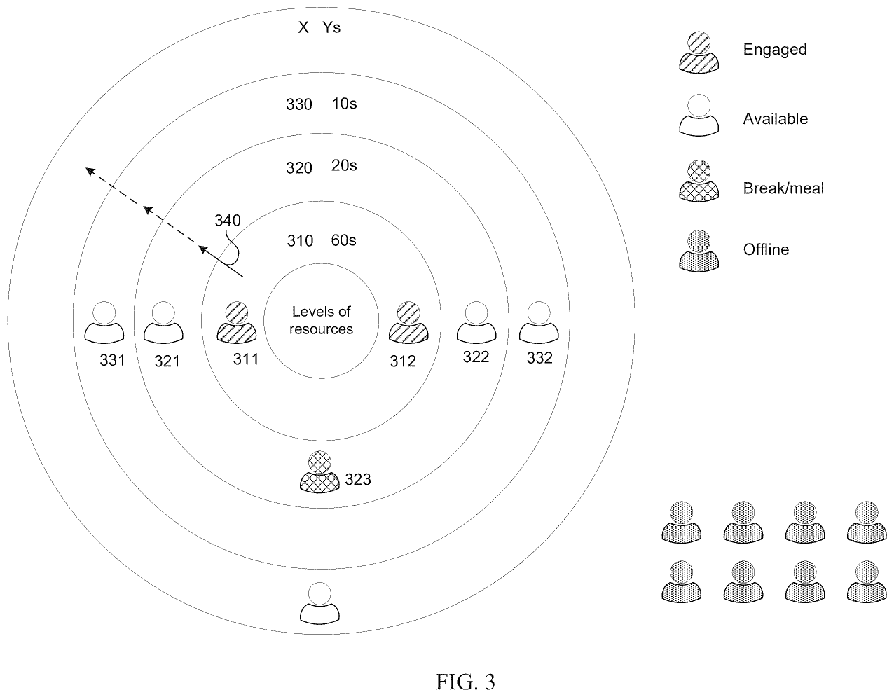

FIG. 3 illustrates multiple levels of resources, according to an embodiment. According to an embodiments, resources may be classified into different levels e.g., primary 310, secondary 320, tertiary 330 etc., as shown based on a received request and resource profiles. As illustrated, each resource at each level may indicate a status. For example, at level 310 which may be considered a primary level, each resources 311 and 312 is indicated to have an engaged status indicating that each resource is currently working on a task. At the second level 320, one resource 323 indicates a status of being on break or meal, while the two resources 321 and 322 indicate an available status. At the third level 330, each resource 331 and 332 indicates an available status as shown. Accordingly, in determining an appropriate resource to respond to a received request, embodiments may initially evaluate the primary resources for availability to respond to the request. In the current example, resources 311 and 312 are engaged and thus unavailable to respond to the request. In some embodiments, a status other than an available status (e.g., engaged, on break/meal, offline, etc.) is considered an unavailable status. Provided that the primary resources are unavailable, the request is dynamically progressed 340 by automatically escalating, in real-time, the request to an alternative resource. In some embodiments, the alternative resource may be a resource at an alternative level, such as in this case, the alternative resource may be resource 321 or 322 at the second level 320.

In some embodiments, each level of resources may be assigned one or more of: a desired response time, a threshold response time, among other time durations as described herein. For example, the primary level 310 is assigned 60 seconds(s) to respond to a request, where upon termination, the request is escalated to an alternative resource according to one or more embodiments. This embodiment provides an example illustrations of how resources may be organized for (re)allocation and readiness, enabling the system to dynamically adjust to the changing needs of the workplace and ensure that resources are effectively utilized.

Embodiments may provide for an interactive feature that enhances resource (e.g., personnel) performance by offering real-time, situation-specific advice and training. This feature may adapt to various scenarios, delivering tailored guidance to improve customer interactions, sales techniques, and adherence to operational standards. This interactive feature may be referred to as a “tip card.” Tip cards may offer immediate, situation-specific advice to resources, guiding them on appropriate actions to take during interactions (e.g., customer interaction), which may help address needs promptly and effectively.

In some embodiments, the effectiveness of each tip card may be tracked by analyzing the outcomes of the engagements where they were used, which may enable continuous learning and adaptation. For instance, it may evaluate whether a specific tip card led to a higher conversion rate, refining and improving the advice provided in future interactions. Tip cards may also provide resources with reminders of seasonally relevant procedures, sales techniques, and engagement strategies, including check-in questions, micro-learning opportunities through quizzes, and observational prompts to maintain workplace standards. Tip cards can also include prompts for achieving sales goals, such as ensuring each customer has a certain number of items in their cart and recommendations for relevant add-ons.

Tip cards may further provide dynamic content updates prompted by seasonal changes or new product launches, ensuring resources are always equipped with the most relevant information and strategies.

An example of how tip cards may be used in a retail setting may include guiding a resource assisting a customer interested in buying an air fryer by suggesting questions such as inquiring about the customer's family size to recommend the ideal capacity, thereby personalizing the interaction and increasing the likelihood of a sale. In inventory management, tip cards may provide resources with guidance during low customer traffic periods. For example, if a product cannot be found in its designated location, the tip card might suggest checking previous storage or display areas where the item was stocked before, as well as alternative sections of the store where similar items may be misplaced. In the hospitality industry, tip cards might suggest strategies for upselling services or amenities based on guest preferences, thereby enhancing the customer experience and increasing revenue.

In some embodiments, tip cards is integrated with performance metrics to encourage continuous improvement. By providing resources with real-time feedback and actionable tips, tip cards may foster a culture of continuous improvement, where resources are encouraged to apply new strategies and learn from their experiences. This may lead to better interactions and higher performance levels across various operational contexts.

Tip cards can have an impact on operational effectiveness. For example, during the holiday season, tip cards may provide advice on promoting gift items or holiday-specific promotions, helping resources increase sales and enhance customer satisfaction. In a busy retail environment, tip cards might offer strategies for managing multiple customer interactions simultaneously, ensuring that no customer feels neglected.

By integrating real-time, actionable direction with continuous learning and adaptation, tip cards may serve as a useful tool for enhancing resource performance, improving customer satisfaction, and driving higher conversion rates. Tip cards can transform each request into an opportunity for learning and growth, ensuring that resources are adequately equipped with effective approaches to meet customer needs. In some embodiments, machine learning may continuously evaluate and refine the effectiveness of tip cards, making them increasingly suited to each resource interaction over time.

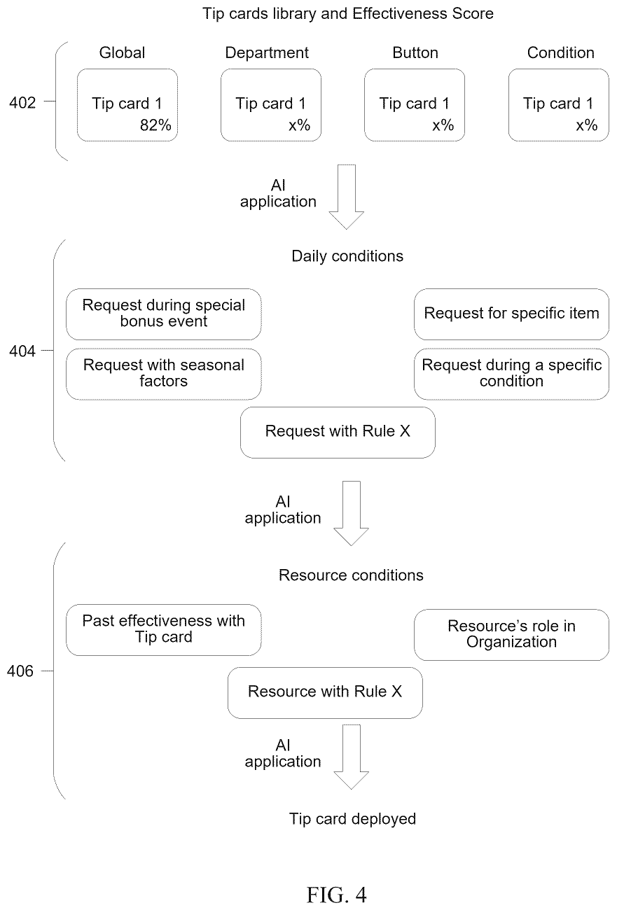

FIG. 4 illustrates deployment of a tip card, according to an embodiment. Tip cards may be stored at a tip card library where a collection of predefined tip cards are organized or classified into various categories 402, such as Global, Department, Button, and Condition among others. The tip card library provides resources with situational advice tailored to specific scenarios to improve their interactions and performance. Each tip card may have a corresponding effectiveness score which is continuously updated. In some embodiments, each category allows efficient sorting and selection of tip cards based on specific criteria relevant to the operational environment.

In some embodiments, the deployment of a tip card may be based on one or more factors, including the category 402 under which the tip card is classified, daily conditions 404, and resource conditions 406, as illustrated. In some embodiments, the RRP may be used to determine the appropriate category from which a tip card may be selected for deployment.

In some embodiments, the global category includes tip cards that apply universally across all departments and scenarios. These are general tips that can be useful in a wide range of situations. In some embodiments, the department category includes tip cards tailored to specific departments within the organization, ensuring that advice is relevant to the unique challenges and needs of each department. In some embodiments, the button category includes tip cards activated by specific triggers, such as the press of a help button or another direct request from a resource or customer. In some embodiments, the condition category includes tip cards designed for specific conditions or scenarios, such as peak shopping hours or during a promotional event.

In some embodiments, daily conditions 404 further refine the selection of a tip card for deployment. Daily conditions include one or more factors that might affect the relevance and effectiveness of a tip card. In some embodiments, daily conditions include the occurrence of a promotional event, which refines the selection of tip cards to provide resources with strategies specifically designed to capitalize on the event. In some embodiments, daily conditions include seasonal factors, such as holidays or specific times of the year, which refine the selection of tip cards to equip resources with relevant strategies that align with the seasonal context. In some embodiments, daily conditions include requests involving specific products, which refine the selection of tip cards to offer tailored advice, helping resources provide detailed and effective information about those products. In some embodiments, daily conditions include unique or unusual operational circumstances, such as high customer volume, which refine the selection of tip cards to guide resources in effectively managing these challenges. In some embodiments, daily conditions include predefined rules or criteria, which refine the selection of specialized tip cards to be deployed when certain conditions are met, ensuring that resources receive the most relevant guidance.

In some embodiments, these daily conditions are analyzed with historical effectiveness to select an appropriate tip card for each situation, ensuring that resources receive effective guidance. Analyzing daily condition may involve using artificial intelligence and real-time data.

In some embodiments, after considering the daily conditions, the specific conditions 406 of the resource receiving the tip card are considered. These resource conditions further refine the selection of an appropriate tip card. In some embodiments, resource conditions include the resource's historical effectiveness with specific tip cards, which refines the selection process by prioritizing tip cards that have previously yielded positive outcomes for that resource. In some embodiments, resource conditions include the resource's role within the organization, refining the selection of tip cards to ensure that the advice provided is directly relevant to the resource's duties and responsibilities. In some embodiments, resource conditions include predefined rules or criteria associated with the resource, which refine the selection of tip cards to align with the resource's specific conditions or requirements.

The tip card may be communicated to a resource as an instruction, an instructional prompt, a guidance module or prompt, an action prompt, or other appropriate means.

As described, the selection of a tip card involves analyzing various conditions at category level, daily level and resource level. The selected tip card is then provided to the resource, offering actionable, situation-specific advice. In some embodiment, throughout this process, AI may be used to continuously refine the selections based on feedback and performance data, ensuring that tip cards remain effective and are adapted to meet the evolving needs of the workplace.

Some embodiments may provide for active resource or roster monitoring and dynamic management, where a real-time overview of active resources and their current engagements is maintained. Embodiments may allow for continuous oversight of each resource's status and location, ensuring effective management and optimal utilization. When a resource responds to a request, the progress of response and the status of the request may be monitored throughout the engagement to ensure that the resource is used effectively.

In some embodiments, if the resource exceeds an expected arrival time (e.g., expected arrival threshold) for the request, and it is assumed that the delay is due to an oversight in status updating (such as the resource personnel forgetting to click “Arrive” in the application), a status of the resource may be automatically updated to indicate an arrived status (indicating that the resource has arrived at the location of the request). The arrived status may then trigger an engagement counter associated with the resource and the request to begin.

In some embodiments, if the resource exceeds the expected arrival time for the request, the request may be reassigned to one or more other resources if it is assumed that the resource cannot fulfill the request, maintaining the original time of the request and re-establishing its priority. For example, if a customer has been waiting for 25 seconds when the resource (e.g., an employee) signals or indicates a delay, the reassigned resource will understand or be aware that the customer has already been waiting for that duration (e.g., those 25 seconds). Additionally, in some embodiments, the current active roster of resources is reanalyzed to appropriately redeploy the request, ensuring that its priority is maintained relative to other pending requests.

In some embodiments, the duration of active engagements may be monitored and the resource's active engagement time may be compared to an anticipated time. If a request takes longer to progress than expected or if difficulties are encountered, a notification indicating an extended engagement longer than expected time may be sent to higher-levels responsible to oversee the completion of the request (i.e., Management). In some embodiments, the notification may be sent to the resource and the higher-level responders at intervals or periodically to help prevent the oversight of not ending their engagement.

Embodiments considers various factors such as resource responsibilities, experience, shift lengths, training status, breaks, upcoming shifts, organizational hierarchy, and historical performance in managing resources. This comprehensive understanding enables the identification and resolution of deficiencies, including insufficient coverage in specific areas, lack of required active training, imbalances in personnel assignments during high-load periods, and excessive overlap of meal breaks. By integrating these monitoring capabilities, the system enhances overall resource management and operational efficiency.

Some embodiments may provide for a comprehensive understanding and monitoring of resources, including their respective areas of responsibility, experience levels, shift durations, training records, break and mealtimes, upcoming shifts, and organizational hierarchy among other aspects. Some embodiments may track performance metrics related to business operations, such as sales figures, customer counts, and transaction volumes. Using this data, embodiments can identify and analyze patterns to optimize resource allocation and provide notifications to operators regarding current and anticipated deficiencies. Such deficiencies may include, but are not limited to area deficiencies, training deficiencies, escalation deficiencies, overlapping meals. Training deficiencies may refer to gaps in required active training for resources. Escalation deficiencies may refer to inadequate resource allocation during high business load, resulting in either overstaffing or understaffing in certain areas. Overlapping meals may refer to excessive numbers of resources taking meals simultaneously, potentially leading to coverage issues.

In some embodiments, resource and performance data are comprehensively tracked and analyzed to ensure operational efficiency and effectiveness. By systematically monitoring various aspects of resource management and business performance, deficiencies in areas such as coverage, training, and scheduling, among others can be identified and addressed.

In some embodiments, determining deficiencies in resource allocation may involve determining if there is inadequate coverage in specific areas by comparing current resource levels against historical data and projected demand. For instance, if an area consistently shows a high volume of customer interactions but has fewer resources assigned compared to other areas, it may indicate an area deficiency. In some embodiments, determining deficiency in resource allocation may involve using historical data and real-time metrics to identify recurring patterns or anomalies. For example, a recurring issue with insufficient coverage in a high-traffic area during peak hours can be detected through pattern recognition. Based on the deficiencies identified, adjustments to resource allocation may be recommended. This may include assigning additional resources to high-traffic areas or rescheduling shifts to ensure adequate coverage.

In some embodiments, determining training deficiencies may involve identifying gaps in required training by comparing the training records of resources against the required training schedules. Resources missing mandatory training or certifications can lead to training deficiencies. Based on the deficiencies identified, additional training or certification sessions for resources with identified training deficiencies may be suggested.

In some embodiments, determining escalation deficiencies may involve evaluating if resources are appropriately assigned during high-load periods by analyzing the relationship between resource availability and business load. For example, if the organization is experiencing a high volume of transactions but there are too few resources available, it signals an escalation deficiency.

In some embodiments, determining overlapping meals may involve analyzing shift schedules and break times to identify patterns that may lead to coverage issues, such as overlapping breaks or shifts that leave certain areas understaffed. Based on identified overlapping meals, changes to shift schedules and break times may be proposed to address overlapping mealtimes or to balance resource distribution during peak periods.

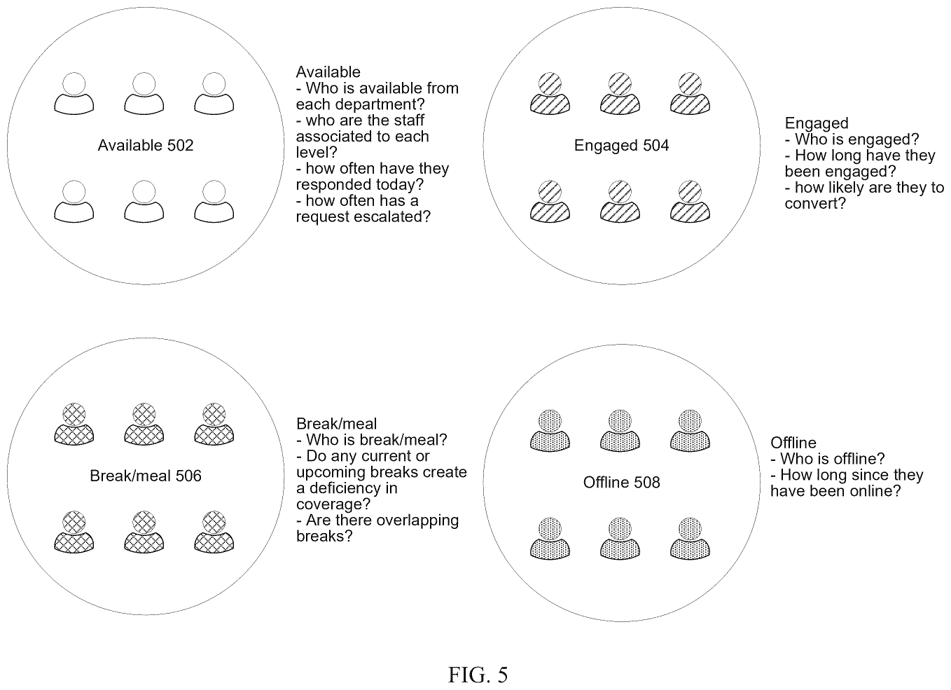

FIG. 5 illustrate a framework for real-time monitoring and management of resources, according to an embodiment. In some embodiments, resources are continuously monitored to ensure that that they are effectively managed, with their current status continuously tracked to optimize their deployment in real-time. While only four types of statuses are shown, other types of statuses may also be tracked and used in managing the resources.

In some embodiments, resources are monitored to determine those currently available 502 in each department, thereby enabling a quick assessment of departmental staffing levels. This allows for the identification of departments that are adequately staffed versus those needing additional resources. In various embodiments, available resources are categorized into different levels as described herein. This categorization facilitates the matching of resources to tasks based on their qualifications and responsibilities. Metrics such as the frequency of responses by available resources and the rate of request escalations provide insights into resource workload and potential inefficiencies in task handling.

In some embodiments, resources that are actively engaged 504 are monitored during their engagement. This metric may assist in managing workload distribution, preventing both overburdening and underutilization of resources. Additionally, the likelihood of successful task completion is assessed based on current engagement, which supports prioritization of follow-ups or additional support.

In some embodiments, resources 506 that are break or meal periods are monitored for identifying those temporarily unavailable and assessing the impact on coverage. This includes evaluating whether overlapping breaks could result in insufficient coverage and suggesting reallocations to maintain operational efficiency. In some embodiments, resources that are offline 508 are monitored, including the duration of their unavailability. This information may be used to manage long-term resource availability and to make informed decisions about scheduling and deployment.

Some embodiments may apply continuous learning and adaptation to enhance efficiency and effectiveness. In some embodiments, the amount of time a resource is engaged and how this affects conversion rates are analyzed, and through this analysis actionable insights for optimizing engagement durations are provided. In some embodiments, the results of each engagement are evaluated based on the effectiveness of the tip cards presented, helping to refine and improve future tip cards. In some embodiments, the impact of arrival times on conversion rates are tracked to ensure that quicker responses lead to higher success rates. In some embodiments, the distribution of resources at one or more levels are assessed in responding to requests, learning from each interaction to balance workload and improve response times.

In some embodiments, during low customer load periods, training opportunities may be suggested and resources are reallocated to improve resource use. In some embodiments, during high customer load periods, primary resources (resources at primary level) are increased in areas with higher traffic, and if resource deficiency is identified, one or more resources may be reallocated to alleviate identified deficiencies. Similarly, if other deficiencies are identified, e.g., deficiency in skill or coverage, according to some embodiments, advance alerts can be issued to appropriate responsible resources (e.g., managers, supervisors), allowing for proactive adjustments.

In some embodiments, upon completing the engagement, resources may record the outcome. Embodiments may provide for recording relevant details including response time, active engagement time, the resolution provided, customer feedback, and any required follow-up actions. This data may inform future dispatch and decision-making processes. Some embodiments may integrate with loyalty programs to capture customer interactions at the point of engagement and track sales conversions for each resource by monitoring register scans.

This continuous learning process may enhance resource management by identifying patterns and outcomes, allowing for dynamic responses that meet the changing needs of the workplace. By recording outcomes such as the time of day, day of the week, and customer wait times, future engagements can be optimized based on customer behavior. This approach may facilitate an understanding of labor requirements, enabling recommendations for both increases and decreases in resource allocation based on load and performance, and predictions of future training needs. In some embodiments, factors influencing training needs include one or more of: the number of trained resources, seasonality, training duration, required observations before resources are considered trained, and anticipated work hours.

In some embodiments, conversion-based deployment can also be facilitated. During low customer load periods, high-converting and low-converting resources may be assigned to the same area, enabling observation and learning. This approach may enhance sales performance and fosters continuous development among resources.

In some embodiments, the result of the engagement is fed back for analysis. Analyzing performance metrics and outcomes may allow for continuous refinement to improve the accuracy and efficiency of resource deployment. In some embodiments, resources may receive feedback and earn badges or rewards based on their performance, linked to training progress and performance milestones. As resources complete training modules and demonstrate proficiency in various tasks, they earn badges reflecting their achievements.

To foster a collaborative and supportive work environment, some embodiments may include a peer-to-peer reward system, where resources can recognize and reward colleagues for exemplary performance, teamwork, and assistance. This may promote a positive workplace culture and encourages collaboration in achieving common goals.

In some embodiments, relevant data may be collected to provide insights into operational deficiencies, customer behavior, resource engagements, engagement outcomes and individual resource performance. These insights may be presented through dashboards, offering management real-time strategic suggestions and opportunities for operational adjustments. In some embodiments, collected data is aggregated to learn about the operational needs of a workplace. Using this information, future needs, such as staff deficiencies and training deficiencies may be determined and events based on increased request load may be predicted.

In some embodiments, labor requirements within a workplace are continually assessed, allowing for recommendations regarding both increases and decreases in resources based on workload and performance metrics. Some embodiments may predict future training needs within the workplace. Factors influencing these predictions include one or more of: the number of currently trained resources, the seasonality of training programs, the duration required to complete training, the number of observations needed before a resource is considered fully trained, and the anticipated work hours for each resource. One or more relevant data can be accessed and reviewed at various levels, including individual resources, specific departments, multiple departments, or the entire workplace.

For example, a workplace might track the number of successful upsells during customer interactions, providing insights into effective sales strategies and informing future training. An outcome could involve an intervention requiring resource assistance, such as handling bulk items or reaching high shelves. Another outcome might be a conversion involving direct sales interactions, such as selling an item or providing product knowledge. Enhancements could include scenarios where a resource's presence is acknowledged by customers, such as being already helped, directed, or still browsing. Additionally, workplaces can track negative results, such as lost sales opportunities due to slow response (e.g., customer leaving) or lack of inventory.

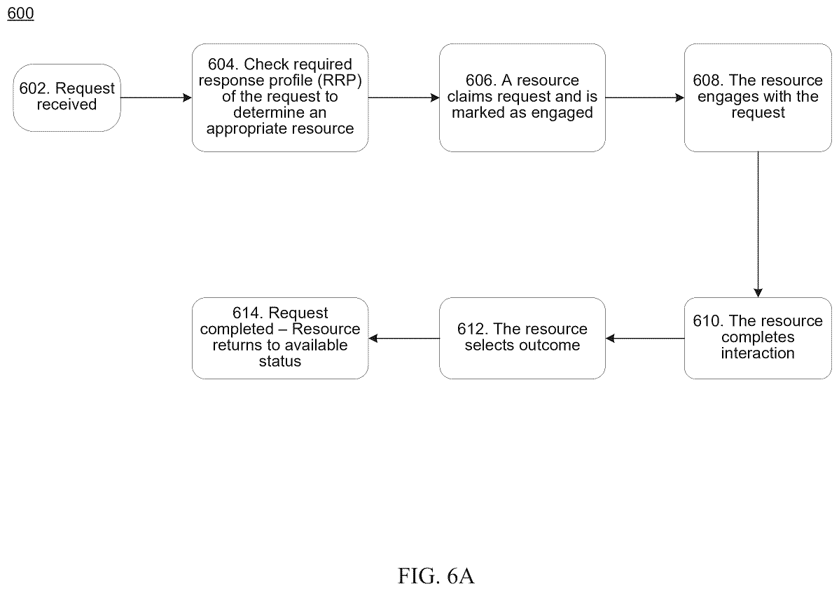

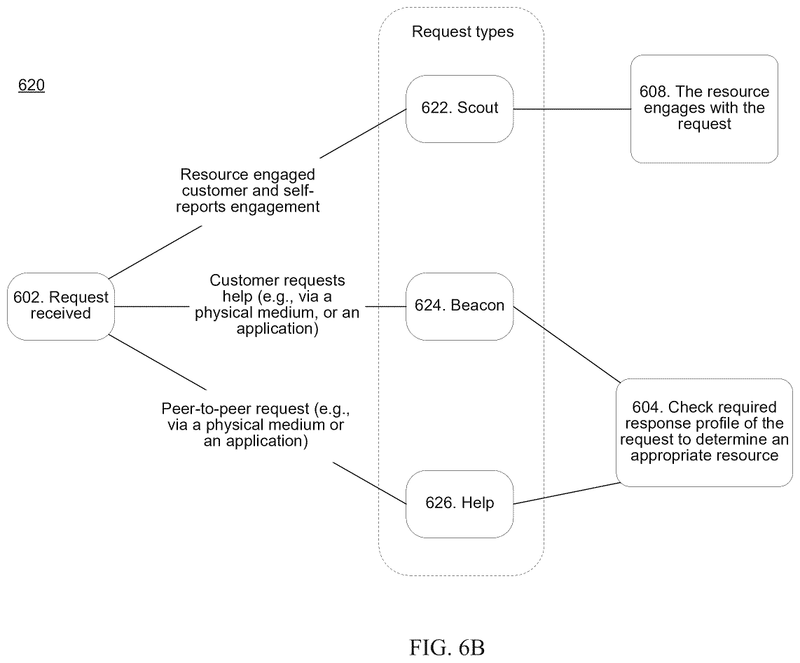

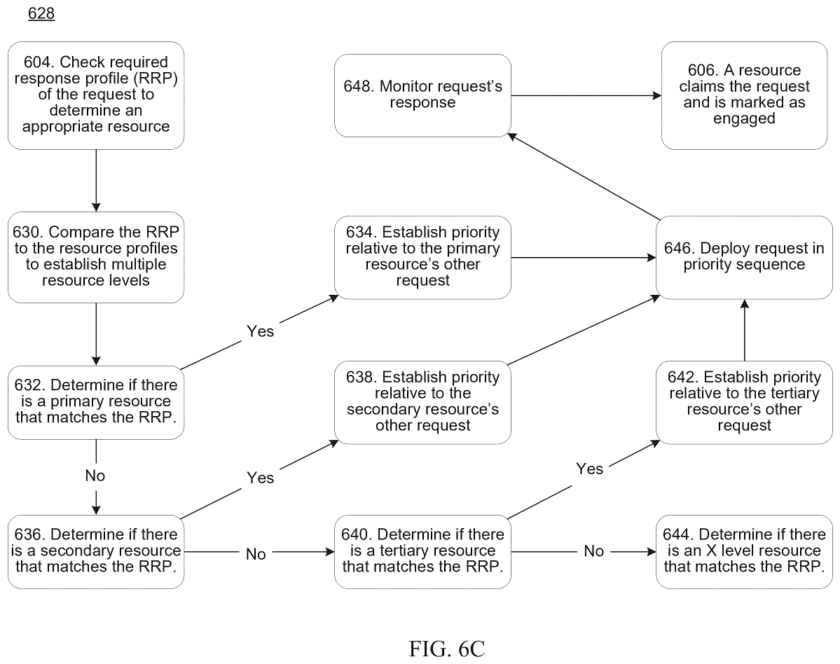

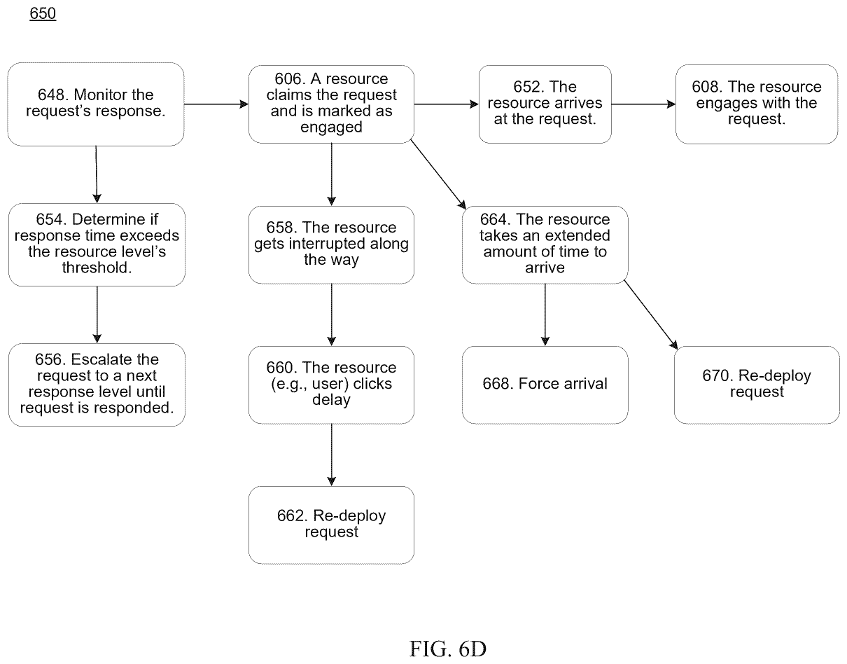

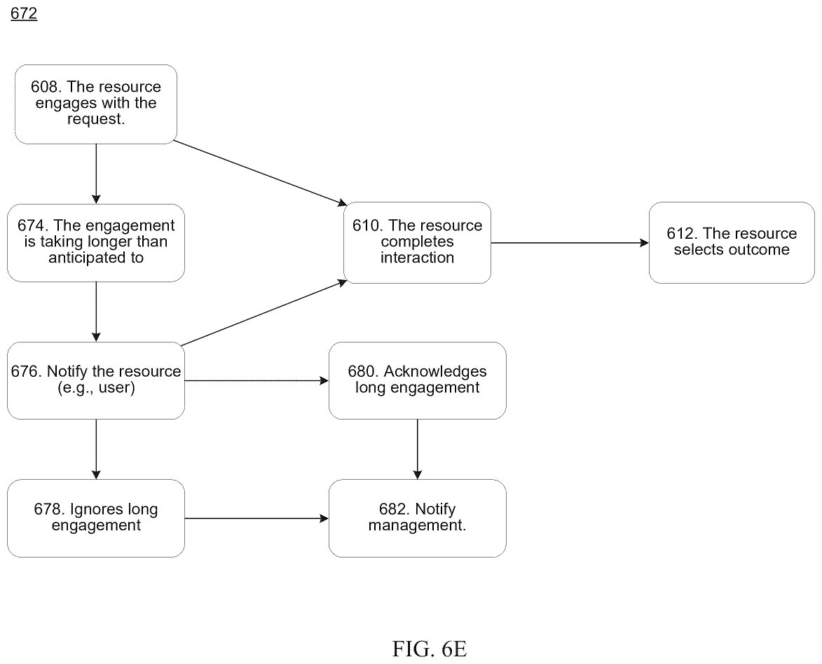

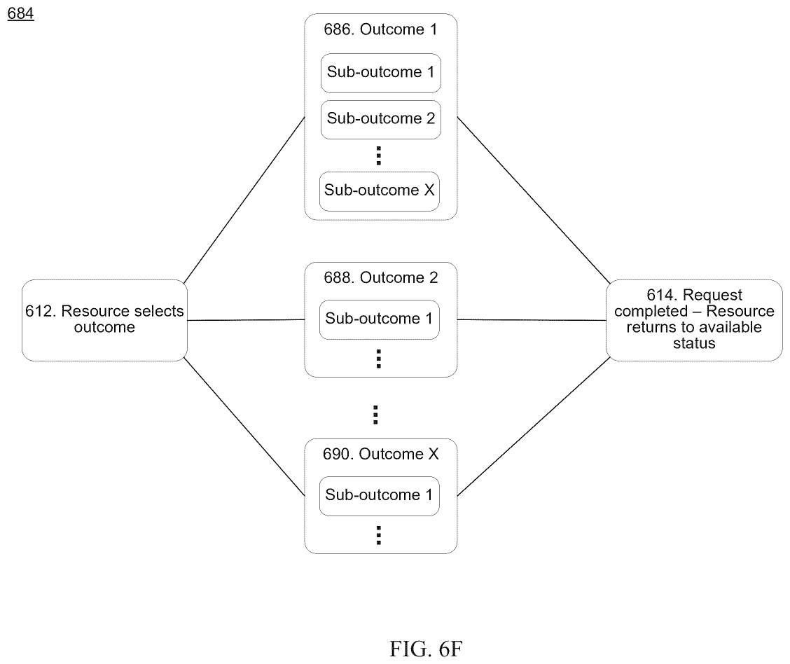

FIGS. 6A to 6F illustrates flowcharts of a response structure, according to an embodiment. FIG. 6A illustrates a flowchart for initial request handling and engagement process, according to an embodiment. Flowchart or process 600 illustrates a workflow for handling a request, beginning from when the request is received to when an appropriate resource completes the engagement and selects an outcome. The process 600 begins when a request for assistance is received 602. This request could be initiated by a customer or generated based on system conditions. Process 600 further includes checking 604 the RRP associated with the request to determine an appropriate resource for the request by evaluating various factors as described herein. Once an appropriate resource is identified based on the RRP, the resource claims 606 the request and is marked as engaged. This status update ensures that the resource is now dedicated to addressing the request. The resource begins to engage 608 with the request. This could involve interacting with a customer, addressing a technical issue, or performing any task related to the request. After fulfilling the requirements of the request, the resource completes the interaction 610. This step marks the conclusion of the active engagement phase. Following the completion of the engagement, the resource may select 612 an outcome that best describes how the request was handled. After selecting an outcome, the request is marked as completed 614, and the resource returns to an available status, ready to take on new requests.

FIG. 6B illustrates a flowchart for request types and engagement initiation, according to an embodiment. In some embodiments, flowchart or process 620 is based on and/or can be combined with flowchart 600. Flowchart 620 illustrates the different types of requests and how resources engage with them. In some embodiments, the request received is based on the Scout function or feature 622 where a resource proactively engages with a customer as described herein. For instance, a resource might approach a customer to offer assistance without being prompted. The resource may then begin engaging the customer 608. In some embodiments, the request received is based on a beacon 624 triggered by the customer using a physical or digital medium to request help. This could involve pressing a button in-store or using an app to request assistance. In some embodiments, the request received is based on a help function 626 which allows for requests to be made between resources, such as one resource asking another for assistance in handling a task. Where the request is based on a beacon 624 or a help function 626, the process 620 includes checking the RRP to determine an appropriate resource.

FIG. 6C illustrates a flowchart for multi-level resource allocation and priority establishment, according to an embodiment. In some embodiments, flowchart or process 628 is based on and/or can be combined with one or more flowcharts including 620 and 600. Process 628 compares the RRP with resource profiles to establish multiple levels of resource engagement, and further describes how priorities are assigned within each level.

According to an embodiment, after checking 604 the RRP to determine the required attributes for the resource needed to handle the request, process 628 includes comparing 630 the RRP against resource profiles to establish various resource levels (e.g., primary, secondary, tertiary, etc.) as described herein. The resources include those that are present at the organization with a status other than offline, indicating the resources are scheduled to be present at the organization when the request is received.

In some embodiments, process 628 includes determining 632 if there is a primary resource that matches the RRP. In some embodiments, determining 632 if there is a primary resource that matches the RRP is part of establishing multiple resource levels. In some embodiments, if there is a primary resource that matches the RRP, process 628 includes establishing 634 the priority of the current request relative to other requests that the primary resource is handling. This step may ensure that the resource is not overwhelmed and that high-priority tasks are addressed first. This may occur, for example, if a primary resource is present, however, the primary resource is engaged with another task. In some embodiments, a primary resource may be available and the request is deployed 646 to the available resource and the response is then monitored 648.

In some embodiments, if there is no primary resource that matches the RRP (e.g., no primary resource is present or all primary resources are unavailable due to being engaged, on break, or otherwise), process 628 includes determining 636 if there is a secondary resource that matches the RRP. In some embodiments, determining 636 if there is a secondary resource that matches the RRP is part of establishing multiple resource levels. In some embodiments, if there is a secondary resource that matches the RRP, process 628 includes establishing 638 the priority of the current request relative to other requests that the secondary resource is handling. This step may ensure that the resource is not overwhelmed and that high-priority tasks are addressed first. This may occur, for example, if a secondary resource is present, however, the secondary resource is engaged with another task. In some embodiments, a secondary resource may be available and the request is deployed 646 to the available resource and the response is then monitored 648.

Similarly, in some embodiments, if there is no secondary resource that matches the RRP (e.g., no secondary resource is present or all secondary resources are unavailable due to being engaged, on break, or otherwise), process 628 includes determining 640 if there is a tertiary resource that matches the RRP. In some embodiments, determining 640 if there is a tertiary resource that matches the RRP is part of establishing multiple resource levels. In some embodiments, if there is a tertiary resource that matches the RRP, process 628 includes establishing 642 the priority of the current request relative to other requests that the tertiary resource is handling. This step may ensure that the resource is not overwhelmed and that high-priority tasks are addressed first. This may occur, for example, if a tertiary resource is present, however, the resource is engaged with another task. In some embodiments, a tertiary resource may be available and the request is deployed 646 to the available resource and the response is then monitored 648. In some embodiments, if there is not tertiary resource that matches the RPP (e.g., no tertiary resource is present or all secondary resources are unavailable due to being engaged, on break, or otherwise), process 628 includes further iteration(s) of determining operations 644 until a resource at level X is found to respond to the request.

In some embodiments, upon establishing 634, 638 and 642 priority relative to the resource's other request, process 628 including deploying the request in priority sequence. In some embodiments, process 628 further includes monitoring 648 the response to the request, ensuring that the request is claimed within the expected timeframe and that escalation occurs if necessary. In some embodiments, process 628 includes a resource claiming 606 the request and updating its status as engaged with respect to or in association with the request.

FIG. 6D illustrates a flowchart for monitoring and escalation during resource engagement, according to an embodiment. In some embodiments, flowchart or process 650 is based on and/or can be combined with one or more flowcharts including 628, 620 and 600. Process 650 describes the monitoring of resource engagement and the conditions under which a request is escalated or reassigned (re-deployed).

In some embodiments, after monitoring 648 the request's response, the determined resource claims 606 the request and is marked as engaged. In some embodiments, the resource arrives 652 at the request and begins engaging 608 with the request. In some embodiments, the resource's arrival time is recorded for further monitoring purposes.

In some embodiments, after monitoring 648 the request's response, process 650 includes determining 654 if the response time exceeds a pre-established threshold. If the resource fails to respond within the allowed time, the request is escalated 656 to a next response level as described in one or more embodiments herein.

In some embodiments, after a resource claims the request 606 and is marked as engaged, the resource may get interrupted 658 before reaching the request, such as encountering obstacles or receiving higher-priority tasks. In such embodiments, the resource may indicate that the response will be delayed 660 via, e.g., a delay feature. The resource may click a “delay” button to indicate that they are delayed in responding to the request. Where delay is indicated by the resource, the request may be re-deployed 662 to an alternative resource as described herein. In some embodiments, after a resource claims the request 606 and is marked as engaged, if the resource takes longer than expected to arrive 664, further actions, such as force arrival (668) or re-deploying the request (670), may be initiated.

Process 650 may allow for monitoring resource engagements in real-time and take appropriate actions, such as escalation or reassignment, to ensure requests are handled promptly

### And Effectively.

FIG. 6E illustrates a flowchart for handling extended engagements and notifications, according to an embodiment. In some embodiments, flowchart or process 672 is based on and/or can be combined with one or more flowcharts including 650, 628, 620 and 600. Process 672 may be used for managing situations where a resource's engagement with a request takes longer than anticipated, including notifying relevant parties and determining the outcome of the engagement.

In some embodiments, process 672 includes the resource engaging 608 with the request and completing the engagement or interaction 610. In some embodiments, after engaging 608 with the request, the resource may take longer than expected during engagement 674. In such embodiments, the resource is notified 676 about the prolonged engagement, prompting the resource to address the issue and/or provide an explanation. In some embodiments, the resource may have forgotten to mark the engagement as complete and thus after the notification 676, the resource may mark the engagement as complete 610. In some embodiments, after the notification 676, the resource may speed up the engagement to complete the interaction. In some embodiments, after notification 676 the resource may acknowledge the notification, confirming they are aware of the extended time and are continuing to address the request. In some embodiments, the resource may ignore 678 the notification of prolong engagement. In some embodiments, if the engagement continues to be delayed or the resource ignores notifications, management is alerted 682 to intervene. Once the engagement is completed, the resource selects 612 the appropriate outcome, which may be from one or more options provided.

Process 672 may allow for managing extended engagements, ensuring that resources are monitored and that any delays are promptly addressed to maintain operational efficiency.

FIG. 6F illustrates a flowchart for outcome selection and detailed reporting, according to an embodiment. In some embodiments, flowchart or process 684 is based on and/or can be combined with one or more flowcharts including 672, 650, 628, 620 and 600. In some embodiments, after completing the engagement, the resource selects 612 one or more appropriate outcome(s), reflecting how the request was resolved. In some embodiments, one or more outcomes are categorized into various types, such as “Outcome 1” 686, “Outcome 2” 688, “Outcome X” 690” etc. In some embodiments, each outcome can have one or more sub-outcomes (e.g., “Sub-outcome 1,” “Sub-outcome 2”) that provide further detail about how the request was handled. In some embodiments, the selected one or more outcomes and corresponding sub-outcome(s) are recorded, providing a granular view of the engagement process and its effectiveness. This data may be used for future decision-making and performance analysis. After selecting the outcome, the request may be marked as complete 614, and the resource's status is updated to available, making them ready for new tasks.

In some embodiments, push notifications are utilized to ensure an effective response to each request. The initial notification may be triggered when a button is pressed or when a request is generated in the application, notifying the level 1 resources. As the request escalates or progresses, escalation and progression notifications may be sent to level 2, level 3, and leadership groups based on time thresholds or the availability of preceding resource groups. If all level 1 resources are engaged, the request may be automatically progressed to the next layer of resources, with this logic applied for each subsequent layer. Notifications may be delivered through various methods, including in-app alerts, SMS, and email, ensuring timely responses.

Some examples of push notifications include initial notification, reminder notification, long-engagement notification, staff deficiency notification, skill deficiency notification, real-world notification, and historical notification. An initial notification may refer to a push notification sent to level 1 resources upon the generation of a request. Reminder notifications may refer to notifications sent at preset intervals to ensure that the request is not overlooked.

Long-engagement notifications may alert resources when they have been engaged for an extended period, allowing them to acknowledge or close the request. Additionally, a separate notification at specified intervals may notify management of the resource's prolonged engagement. Staff deficiency notifications may inform management of insufficient resources at one or more levels. Skill deficiency notifications may alert management of a shortage of appropriately skilled resources at one or more levels.

In some embodiments, real-world notifications may be triggered to notify resources of external events occurring in the geographical area that could impact the workplace's stress load and the expected response. For example, if a serious weather event is approaching, embodiments may notify resources of emergency protocols, create hazard alerts, and generate sale opportunity alerts to ensure an effective response. Historical notifications may suggest tasks that were regularly generated at a specific time of day, day of the week, day of the month, or time of year. For instance, if every Monday at 9 pm a request is typically generated to check a piece of equipment, embodiments may suggest scheduling a similar request automatically for the following Monday.

In some embodiments, a role-based team deployment system may be implemented to optimize team-based job assignments by leveraging deployment capabilities for team-based tasks. This system may enhance organizational efficiency by understanding the specific roles required for various tasks, assessing resource capabilities, and forming appropriate teams to achieve improved responses. This functionality can be applied across various organizations to ensure effective and coordinated responses to diverse situations.

In some embodiments, the deployment process begins by analyzing the team-based job and identifying the roles and skills necessary to complete it. The team-based job may be similar to a request where a corresponding required response profile indicates roles and necessary skills required for a plurality of resources to perform the team-based job. In some embodiments, the deployment process further includes assessing the capabilities of available resources by evaluating their resource profiles including training, experience, and current availability and comparing the assessed capabilities with the RRP of the team-based job.

In some embodiments, upon the triggering of an alert, whether for an emergency or a routine task, the system evaluates which resources are best suited to respond based on their roles, skills, and proximity to the incident, among other factors.

In some embodiments, a team may be dynamically formed by selecting qualified resources and reallocating resources as needed. This ensures that the appropriate resources are assigned to the right tasks, and in some embodiments, selection may override existing engagements of the resources. In some embodiments, the priority of each task within a team-based job may be determined similar to determining priorities of a request as described herein including consideration of urgency and criticality, ensuring that the most important issues are addressed first.

In some embodiments, the role-based team deployment system may dynamically assign roles to resources. Dynamic role assignment may involve identifying and assigning roles based on the skills, training, and experience of resources. This may ensure that each team member is equipped to perform the tasks required for the job at hand.

In some embodiments, the role-based team deployment system may allocate resources in real-time, including (re)allocating resources based on priority. This may allow for resources to be deployed where they are needed most, which may enhance response times and overall efficiency.

In some embodiments, the role-based team deployment system may perform skill matching and team formation. This may involve matching the skills of resources with the requirements of each task, forming teams based on performance. This may further include balancing workload and pairing less experienced resources with more experienced colleagues for mentorship and development.

In some embodiments, the role-based team deployment system may continuously learn and adapt to changing environments. According to an embodiment, by analyzing the outcomes of engagements, the system may continuously refine its algorithms to improve future team formations and response strategies. This adaptive learning process may improve response quality.

In some embodiments, the role-based team deployment system may allow for integrated communication. For example, seamless communication among team members may be facilitated through integrated real-time chat features, ensuring coordination and quick responses during tasks and emergencies. In some embodiments, the role-based team deployment system may track performance and provide feedback. For example, the system may log detailed data on response times, engagement duration, resolution effectiveness, and customer feedback. This information may be used to inform future decisions and to continuously improve resource deployment strategies. In some embodiments, the role-based team deployment system may provide proactive alerts and recommendations based on current resource load, skill deficiencies, and predicted future needs. This may help organizations prepare in advance and maintain adequate performance levels.

By leveraging these functionalities, the role-based team deployment system may ensure that organizations effectively manage their resources, respond quickly to changing situations, and continuously improve operational efficiency. This system can be adaptable to various industries and organizational structures, making it a versatile tool for enhancing team-based performance across different contexts.

In some embodiments, a coordinated alert response system may be provided, offering a modular and customizable interface for managers to set up tailored procedures that ensure effective responses to various situations while adhering to standard operating procedures (SOPs). Admin users may create different types of Alerts, such as First Aid, AED, and Theft, each associated with specific procedures and notifications. The system may allow for assigning roles, specifying which organizational roles are responsible for each type of emergency. These roles may be selectable by team or skill, which may foster an effective teamwork and coordination.

In some embodiments, notifications within the system is customized based on the degree of severity. For instance, full-screen alerts may be employed to demand immediate attention, while less intrusive half-page pop-ups may be used for lower-severity situations. Upon completion of an Alert, detailed logs of the event may be generated and made available for export.

In some embodiments, admin users may set up custom questionnaires for resources to complete before, during, or after the Alert. These questionnaires may include both mandatory and optional questions, depending on the needs of the organization. In some embodiments, during an alert, resources may be presented with a structured list of requests or tasks designed to ensure a coordinated response. This list may be customized to follow a specific order or may allow tasks to be claimed in any order, based on the organization's SOPs. This flexibility may allow organizations to tailor their response strategies, ensuring that the critical tasks are addressed first or enabling a more dynamic approach based on real-time needs.

In some embodiments, Alerts is triggered via a button press, within the application, or both. In some embodiments, an admin portal may offer a dedicated section for creating, editing, and managing different types of alerts. Each alert type may include data fields such as a unique identifier (Alert ID), a descriptive name (Alert Name), a list of predefined questions, designated resource roles, notification types, and time intervals for warnings. By providing an intuitive interface, managers may quickly create and customize alerts, ensuring that the system is aligned with the workplace's SOPs. This structured response capability may ensure that team members are aware of their roles and responsibilities, promoting efficient and effective handling of emergencies.

In some embodiments, active roster monitoring may offer a real-time overview of active resources and their current engagements. This feature may allow management to monitor the status and location of each resource, ensuring comprehensive oversight of the workplace.

Some embodiments may provide a real-time list of all active resources, displaying their current status, travel time, location within the workplace or facility, time engaged and other relevant information. The resource engagements may be categorized, for example, into physical button presses, self-reported engagements, and responses to in-app requests. As resources complete tasks or respond to new requests, their status may be dynamically updated, ensuring that management has access to the most current information.

Managers may view historical data on past engagements, providing insights into resource performance and response times. This feature may integrate with an analytics dashboard, offering metrics such as average response time, task completion rate, and individual performance.

For example, during a busy shopping period at a retail workplace, active roster or resource monitoring may enable a workplace manager to see that Jane, a sales associate, is currently assisting a customer with a product query (button press response), while John, another associate, is handling a restocking task (task assigned in-app). The manager may also see that Sarah approached a customer and self-reported this engagement in the application. Real-time tracking and dynamic updates may reduce downtime and ensure that resources are effectively utilized. By providing a comprehensive and real-time overview of resource engagements, management may be improved by enabling informed decision-making and providing tools to monitor the workplace effectively.

In some embodiments, gamification may be integrated into workforce customer engagements and workforce management to enhance workplace experience. Some embodiments may incorporate a comprehensive badge system linked to training progress and performance milestones. As resources complete training modules and demonstrate proficiency in various tasks, they may earn badges that reflect their achievements. For example, a resource may earn a “Plumbing Pro” badge after resolving plumbing issues fifty times or a “Bike Buddy” badge for assisting a child in selecting their first bicycle. These badges may serve both as recognition of skill and as motivation for continued excellence.

In some embodiments, the onboarding process may be transformed by utilizing existing organizational resources to create an engaging in-app training experience. Organizations may upload their own training materials, which are then transformed into interactive modules. This approach may allow resource training to be relevant and tailored to the specific needs of the organization while being engaging and game-like. As resources progress through these modules, their achievements may be recorded, building a comprehensive profile of their skills and competencies. Additionally, these achievements may be easily transferred between roles and added to a user's resume, thereby enhancing their career prospects. Furthermore, some embodiments may enhance the customer experience by creating memorable milestones through gamification elements, ensuring that both resource development and customer interactions are enriched.

In some embodiments, gamified “Sales Modes” may be introduced to energize the sales process. Sales modes may be understood to be dynamic, time-bound events designed to create a competitive and engaging atmosphere on the sales floor. By transforming routine sales activities into exciting challenges, these modes may leverage the competitive nature of resources to drive higher performance and increased sales.

For example, a “Shark Mode” may be activated during peak sales periods, transforming the sales floor into a competitive arena where resources strive to outperform each other in real-time. During “Shark Mode,” resources may compete to achieve the highest sales within a specified timeframe, with rewards or incentives offered to top performers. Leaderboards may display real-time rankings, fostering a sense of urgency and excitement. Recognition of top performers may boost individual morale and motivate others to elevate their performance. This gamified approach may bring enthusiasm and increased effort to high-stakes periods, thereby driving sales and enhancing customer service.

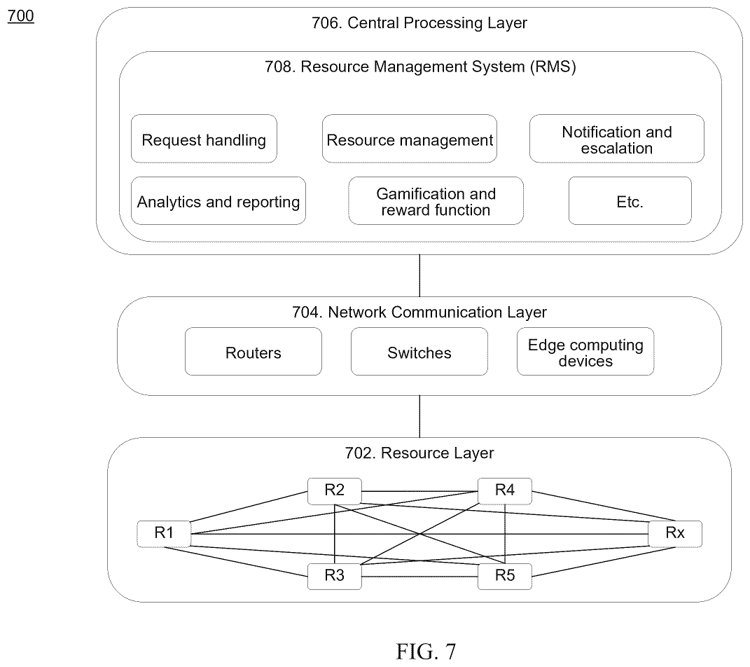

FIG. 7 illustrates a network architecture for implementing a resource management system (RMS), according to an embodiment. In some embodiments, the network architecture 700 includes a resource layer 702, a network communication layer 704, and a central processing layer 706. In some embodiments, the resource layer 702 comprises various endpoints representing resources of the organization. The endpoints can include mobile devices, tablets, workstations, robots, and the like, representing both human and non-human resources. Each resource within this layer may be interconnected and connected to the RMS 708 through a network (e.g., network communication layer 704), allowing them to receive tasks, log relevant data, and update their status in real-time. The connections between these endpoints and the network infrastructure enable seamless communication and interaction with the RMS.

In some embodiments, the central processing layer 706 (e.g., a cloud server or on-premise server) runs the RMS 708. The RMS 708 is responsible for executing various functions such as request handling, resource management, notification and escalation, data analytics and reporting, gamification and reward system, coordinated response system, and others as described herein. These functions may be integrated into a single system or distributed across multiple modules or functions within the RMS.

For example, in some embodiments, the RMS includes a request management function that is responsible for receiving and categorizing requests, evaluating the RRP, and determining the appropriate resource levels (primary, secondary, etc.). In some embodiments, the request management function interacts with a resource management function of the RMS and escalates requests when necessary. In some embodiments, the RMS includes a resource management function that continuously monitors and updates resource profiles, including their status, location, skill set, and engagement history. The resource management function may be responsible for matching resources to requests based on the criteria set by the RRP and for dynamically reallocating resources as conditions change. In some embodiments, the RMS includes a notification and escalation function that handles the delivery of notifications to resources and management teams as described herein. In some embodiments, the notification and escalation function may handle the delivery of tip cards to the appropriate resources at the right time, as part of sending actionable advice in response to specific requests or engagements. The notification and escalation function may ensure that alerts are sent out based on predefined rules (e.g., time thresholds, resource availability) and manages escalation processes. In some embodiments, the RMS includes an analytics and reporting function that gathers data from resource interactions and engagements, providing real-time analytics and historical reporting. The analytics and reporting function may track performance metrics, engagement durations, response times, and other relevant data, feeding it back into the system for continuous improvement. In some embodiments, the RMS includes a gamification and reward function that manages the gamified aspects of the system, including badge assignment, leaderboards, and competitions. The gamification and reward function can interact with the resource management function to ensure that gamification is integrated into everyday operations. In some embodiments, the gamification and reward function could also play a role in selecting relevant tip cards based on the resource's current performance, skills, and the task at hand, integrating the advice into the gamified aspects of the system. The RMS may include other functions that can combine one or more functions described herein and/or include other functionalities needed to perform one or more embodiments described herein. The RMS may continuously interact with the resource layer 702 through the network communication layer 704, ensuring improved resource utilization and efficient task management.

As an example of an operational workflow, when a request is generated, it enters the system through the request management function, which evaluates the RRP and interacts with the resource management function to identify the appropriate resource(s) based on real-time data and historical profiles. The notification and escalation function ensures that the selected resource receives the request and monitors their response. If the response is delayed or the resource is unavailable, the notification and escalation function triggers an escalation according to predefined rules as described herein. As resources engage with the request, the analytics and reporting function collects and processes data, feeding it back into the system to refine future operations. The gamification and reward function integrates with the resource management function to motivate and track resource performance, rewarding them based on the outcomes.

In some embodiments, the network communication layer 704 serves as the backbone of the network, facilitating the transfer of data between the resource layer 702 and the RMS 708. The network communication layer includes communication devices such as routers, switches, edge computing devices and others that manage and route data to ensure efficient communication. Edge computing devices may be used to process data closer to the resources, reducing latency and enhancing real-time decision-making. In some embodiments, the network architecture can use any appropriate communication protocol (e.g., TCP/IP, HTTP/HTTPS,) to ensure reliable data transfer between resources and the RMS 708. In some embodiments, the RMS can be hosted on data servers or cloud infrastructure, providing scalability, redundancy, and centralized control.

This architecture 700 may be adaptable and scalable, supporting a variety of technical environments and organizational needs. In some embodiments, the RMS 708 can be integrated with existing enterprise resource planning (ERP), customer relationship management (CRM), and other organizational tools to streamline operations and enhance data flow.

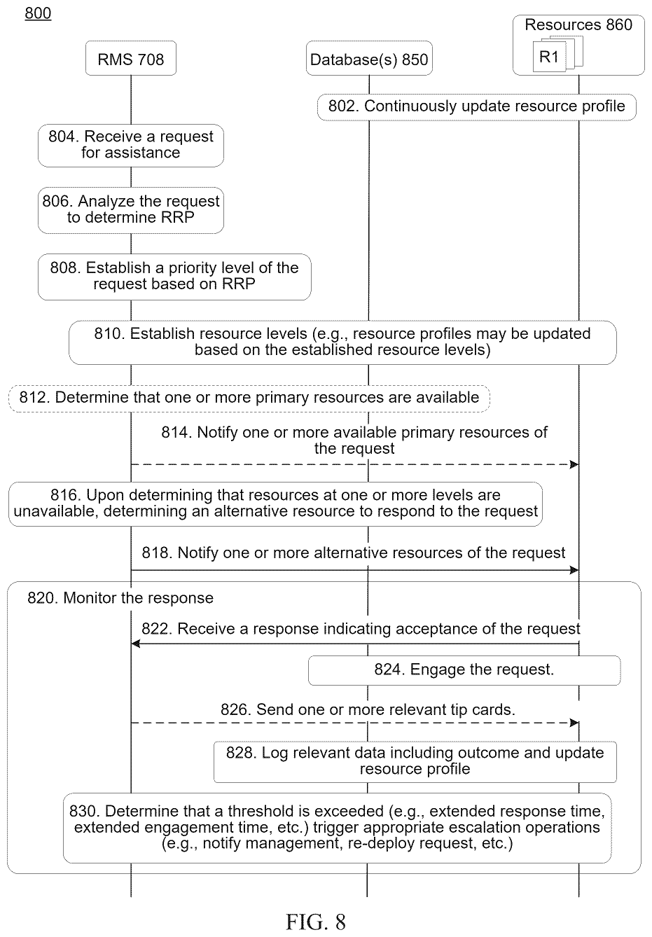

FIG. 8 illustrates a method for managing resources, according to an embodiment. The method 800 depicts the flow of processes and interactions between the RMS 708, resources 860, and database(s) 850 involved in implementing one or more embodiments described herein.

In embodiments described herein, resources continuously update 802, in real-time, their resource profile including their status, skills, location, availability, historical performance among other information as described herein. The resource profile may be stored in one or more local or remote database(s) 850 accessible by the RMS 708.

According to an embodiment, RMS 708 receives a request for assistance 804, which may be initiated by a customer, a resource requesting assistance, a system trigger, or external event. Upon receiving the request, the RMS 708 proceeds to analyze 806 the request to determine the RRP. In some embodiments, the RMS 708 establishes 808 a priority level of the request based on the RRP and other factors as described herein (e.g., urgency of the request and how it should be addressed relative to other active requests).

In some embodiments, the RMS 708 establishes 810 resource levels based on the RRP and resource profiles. This involves categorizing resources into primary, secondary, tertiary, and potentially other levels. The resource levels may be used to determine the order in which resources are notified and tasked with responding to the request. In some embodiments, resource profiles of relevant resources may be updated to indicate the resource levels as established.

In some embodiments, the RRP indicates one or more requirements including: a required skill level and a department of the organization associated with the request among other requirements. In some embodiments, the resource profile of each primary resource indicates the required skill level and the department indicated by the RRP as a primary department.

In some embodiments, the RMS 708 checks whether one or more primary resources are available. In some embodiments, the RMS 708 determines 812 that one or more primary resources are available and sends the request or a notification 814 indicating the request to the one or more available primary resources.

In some embodiments, RMS determines that the primary resources are unavailable 816 (e.g., the primary resources are engaged or are otherwise currently unavailable to respond to the request). Upon such determination, the RMS determines 816, automatically (dynamically and in real-time), an alternative resource to respond to the request. This step may involve evaluating resources at one or more levels including the unavailable (e.g., engaged) primary resources, secondary resources, tertiary resources, or other levels of resources to identify a suitable candidate. The RMS may escalate the request within the primary level or across the different resources levels until one or more alternative resources are determined. Once the one or more alternative resources are identified, the RMS sends the request or a notification 818 indicating the request to the one or more alternative resources.

In some embodiments, the resource profile of each alternative resource indicates the required skill level and the department associated with the request as an alternative department. In some embodiments, each alternative resource is identified further based on one or more of: a role within the organization, proximity to a location of the request, relevant skills, number of similar requests handled, cost of the alternative resource, a response time, performance, resource type.

In some embodiments, RMS 708 determines a set of available resources, wherein each resource of the set of available resources indicates an available status, and wherein the alternative resource is automatically identified from the set of available resources.

In some embodiments, the alternative resource indicates an engaged status associated with a second request, the second request indicating a priority level that is lower than the priority level of the request. In some embodiments, the alternative resource is a primary resource that is engaged.

In some embodiments, the RMS 708 determines a set of engaged resources of the organization, wherein each resource of the set of engaged resources indicates an engaged status, and wherein the alternative resource is identified from the set of engaged resources. In some embodiments, each resource of the set of engaged resources further indicates an unavailable status in addition to the engaged status.

After notifying the resource (e.g., the primary resource or an alternative resource), the RMS may monitor 820 the response. Monitoring includes one or more of tracking engagement times, resource performance, and adherence to the task requirements. The monitoring process may allow the request to be handled appropriately and for real-time adjustments if necessary.

In some embodiments, the RMS 708 receives a response 822 from the notified resource(s), indicating acceptance of the request. The notified resource(s) may proceed to engage 824 with the request and update its resource profile accordingly. In some embodiments, the RMS 708 may send one or more relevant tip cards 826 as described herein to the engaged resource(s). The one or more tip cards 826 may be one or more of: an instruction, an instructional prompt, a guidance module or prompt, an action prompt, or other appropriate means. In some embodiments, the tip card or instruction may provide guidance in responding to the request, the instruction being based on the request and a resource profile of the alternative resource. During and after engagement, the resource updates the resource profile accordingly and logs 828 relevant data (such as task outcomes, time taken, customer feedback).

In some embodiments, the RMS continuously monitors 830 whether any thresholds are exceeded, such as extended response times or prolonged engagement periods. If a threshold is breached, the RMS triggers appropriate escalation operations, such as notifying management, re-deploying the request to another resource, or altering the task parameters to ensure timely completion.

In some embodiments, the RMS may receive one or more outcomes of the request from the alternative resource. In some embodiments, the one or more outcomes of the request include a feedback associated with instruction or tip card, the feedback indicating a usefulness of the instruction in responding to the request

In some embodiments, where the alternative resource was previously engaged with a second request, upon receiving the response from the alternative resource indicating acceptance of the request, the RMS 708 automatically identifies, based on the second request, a second alternative resource within the organization to respond to the second request. The RMS may send the second request to the second alternative resource. The RMS may further receive a response indicting acceptance of the second request from the second alternative resource.

Method 800 illustrates a detailed workflow managed by the RMS in handling requests, allocating resources, and ensuring that tasks are completed efficiently and effectively.

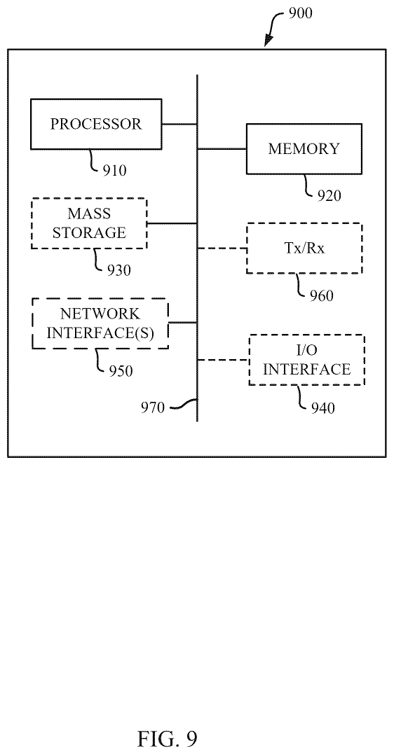

FIG. 9 is a schematic diagram of an electronic device 900 that may perform any or all of operations of the above methods and features explicitly or implicitly described herein, according to different embodiments of the present application. For example, a computer equipped with network function may be configured as electronic device 900. In some embodiments, electronic device 900 can be a device that connects to the network infrastructure over a radio interface, such as a mobile phone, smart phone or other such device that may be classified as user equipment (UE). In some aspects, the electronic device 900 may be a Machine Type Communications (MTC) device (also referred to as a machine-to-machine (m2m) device), or another such device that may be categorized as a UE despite not providing a direct service to a user. In some embodiments, electronic device 900 performs one or more operations in one or more embodiments described herein. In some embodiments, electronic device 100 is one or more of: a network element, an RMS, a resource, a module or a function of the RMS. In some embodiments, electronic device 900 can act as a data processing unit, executing procedures and processing data as specified by the various methods. It may also function as a communication device, transmitting and receiving information across different network layers and protocols. Furthermore, electronic device 900 can serve as a control unit, managing and orchestrating various network elements and resources.

Moreover, electronic device 900 can be one or more of the following: a network element, such as a router, switch, or gateway, facilitating the flow of data across the network; a data storage device, storing data temporarily or permanently for processing or future use; a sensor or actuator, collecting data from the environment or performing actions based on received commands; a user interface device, such as a display or input device, providing interaction capabilities for end-users; a server, hosting applications, services, or databases accessible over the network; a client device, accessing services and resources provided by servers or other network elements; an intermediary device, performing tasks such as load balancing, data caching, or traffic management; a security device, implementing functions like encryption, decryption, authentication, or intrusion detection. These functionalities can be combined in various ways to create systems that perform a wide range of operations as described in the application.

As shown, the electronic device 900 may include a processor 910, such as a Central Processing Unit (CPU) or specialized processors such as a Graphics Processing Unit (GPU) or other such processor unit, memory 920, non-transitory mass storage 930, input-output (I/O) interface 940, network interface 950, and a transceiver 960, all of which are communicatively coupled via bi-directional bus 970. The transceiver 960 is responsible for both transmitting and receiving data, as indicated by the Tx/Rx labels in the diagram. Tx stands for transmission, referring to the sending of data, while Rx stands for reception, referring to the receiving of data. Together, these functionalities enable full bidirectional communication. According to certain embodiments, any or all of the depicted elements may be utilized, or only a subset of the elements. Further, electronic device 900 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 920 may include any type of non-transitory memory such as static random access memory (SRAM), dynamic random access memory (DRAM), synchronous DRAM (SDRAM), read-only memory (ROM), any combination of such, or the like. The mass storage element 930 may include any type of non-transitory storage device, such as a solid state drive, hard disk drive, a magnetic disk drive, an optical disk drive, USB drive, or any computer program product configured to store data and machine executable program code. According to certain embodiments, the memory 920 or mass storage 930 may have recorded thereon statements and instructions executable by the processor 910 for performing any of the aforementioned method operations described above.

In the present disclosure, the terms “a” or “an” are defined to mean “at least one”, that is, these terms do not exclude a plural number of items, unless stated otherwise.

In the present disclosure, terms such as “substantially”, “generally” and “about”, which modify a value, condition or characteristic of a feature of an example embodiment, should be understood to mean that the value, condition or characteristic is defined within tolerances that are acceptable for the proper operation of the example embodiment for its intended application.

In the present disclosure, unless stated otherwise, the terms “connected” and “coupled”, and derivatives and variants thereof, refer herein to any structural or functional connection or coupling, either direct or indirect, between two or more elements. For example, the connection or coupling between the elements can be acoustical, mechanical, optical, electrical, thermal, logical, or any combinations thereof.

In the present disclosure, the expression “based on” is intended to mean “based at least partly on”, that is, this expression can mean “based solely on” or “based partially on”, and so should not be interpreted in a limited manner. More particularly, the expression “based on” could also be understood as meaning “depending on”, “representative of”, “indicative of”, “associated with” or similar expressions.

In the present disclosure, the terms “system” and “network” may be used interchangeably in embodiments of this application. “At least one” means one or more, and “a plurality of” means two or more. The term “and/or” describes an association relationship of associated objects, and indicates that three relationships may exist. For example, A and/or B may indicate the following three cases: Only A exists, both A and B exist, and only B exists, where A and B may be singular or plural. The character “/” usually indicates an “or” relationship between associated objects. “At least one of the following items (pieces)” or a similar expression thereof indicates any combination of these items, including a single item (piece) or any combination of a plurality of items (pieces). For example, “at least one of A, B, or C” includes A, B, C, A and B, A and C, B and C, or A, B, and C, and “at least one of A, B, and C” may also be understood as including A, B, C, A and B, A and C, B and C, or A, B, and C. In addition, unless otherwise specified, ordinal numbers such as “first” and “second” in embodiments of this application are used to distinguish between a plurality of objects, and are not used to limit a sequence, a time sequence, priorities, or importance of the plurality of objects.

A person skilled in the art should understand that embodiments of this application may be provided as a method, an apparatus (or system), computer-readable storage medium, or a computer program product. Therefore, this application may use a form of a hardware-only embodiment, a software-only embodiment, or an embodiment with a combination of software and hardware. Moreover, this application may use a form of a computer program product that is implemented on one or more computer-usable storage media (including but not limited to a disk memory, an optical memory, and the like) that include computer-usable program code.

This application is described with reference to the flowcharts and/or block diagrams of the method, the device (system), and the computer program product according to this application. It should be understood that computer program instructions may be used to implement each process and/or each block in the flowcharts and/or the block diagrams and a combination of a process and/or a block in the flowcharts and/or the block diagrams. The computer program instructions may be provided for a general-purpose computer, a dedicated computer, an embedded processor, or a processor of another programmable data processing device to generate a machine, so that the instructions executed by the computer or the processor of the another programmable data processing device generate an apparatus for implementing a specific function in one or more procedures in the flowcharts and/or in one or more blocks in the block diagrams.

The computer program instructions may alternatively be stored in a computer-readable memory that can indicate a computer or another programmable data processing device to work in a specific manner, so that the instructions stored in the computer-readable memory generate an artifact that includes an instruction apparatus. The instruction apparatus implements a specific function in one or more procedures in the flowcharts and/or in one or more blocks in the block diagrams.

The computer program instructions may alternatively be loaded onto a computer or another programmable data processing device, so that a series of operations and steps are performed on the computer or the another programmable device, so that computer-implemented processing is generated. Therefore, the instructions executed on the computer or the another programmable device provide steps for implementing a specific function in one or more procedures in the flowcharts and/or in one or more blocks in the block diagrams.

Aspects of the present disclosure can be implemented using electronics hardware, software, or a combination thereof. In some aspects, this may be implemented by one or multiple computer processors executing program instructions stored in memory. In some aspects, the invention is implemented partially or fully in hardware, for example using one or more field programmable gate arrays (FPGAs) or application specific integrated circuits (ASICs) to rapidly perform processing operations.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is

1. A method of managing requests at an organization, the method comprising:
receiving a request for assistance, the request including a required response profile indicating one or more requirements for responding to the request;
determining one or more primary resources of the organization for responding to the request based on the required response profile;
upon determining that the one or more primary resources are unavailable to respond to the request, automatically identifying, based on the required response profile, an alternative resource within the organization to respond to the request;
sending the request to the alternative resource; and
receiving, from the alternative resource, a response indicating acceptance of the request.

2. The method of claim 1, wherein each primary resource of the one or more primary resources indicates an unavailable status.

3. The method of claim 1, wherein:
the one or more primary resources of the organization for responding to the request are determined in real-time; and
the alternative resource is identified in real-time.

4. The method of claim 2, wherein:
each primary resource of the one or more primary resources is assigned as a primary resource to respond to the request based on the required response profile and a resource profile of said each primary resource; and
the alternative resource indicates an available status and is assigned as the alternative resource to respond to the request based on the required response profile and a resource profile of the alternative resource.

5. The method of claim 4, wherein:
the one or more requirements for responding to the request indicate a required skill level;
the resource profile of said each primary resource indicates the required skill level; and
the resource profile of the alternative resource indicates the required skill level.

6. The method of claim 5, wherein:
the one or more requirements for responding to the request indicate a department of the organization associated with the request;
the resource profile of said each primary resource indicates the department as a primary department; and
the resource profile of the alternative resource indicates the department as an alternative department.

7. The method of claim 1, wherein the alternative resource is identified further based on one or more of: a role within the organization, proximity to a location of the request, relevant skills, number of similar requests handled, cost of the alternative resource, a response time, performance, and resource type.

8. The method of claim 2 further comprising:
determining a set of available resources of the organization, wherein each resource of the set of available resources indicates an available status, and wherein the alternative resource is automatically identified from the set of available resources.

9. The method of claim 1, wherein:
the request further indicates a first priority level; and
the alternative resource indicates an engaged status associated with a second request, the second request indicating a second priority level lower than the first priority level.

10. The method of claim 9, wherein the alternative resource is a primary resource of the one or more primary resources.

11. The method of claim 9 further comprising:
determining a set of engaged resources of the organization, wherein each resource of the set of engaged resources indicates an engaged status, and wherein the alternative resource is identified from the set of engaged resources.

12. The method of claim 11, wherein each resource of the set of engaged resources further indicates an unavailable status in addition to the engaged status.

13. The method of claim 9 further comprising:
upon receiving the response indicating acceptance of the request, automatically identifying, based on the second request, a second alternative resource within the organization to respond to the second request;
sending, to the second alternative resource, the second request; and
receiving, from the second alternative resource, a second response indicating acceptance of the second request.

14. The method of claim 9, wherein the engaged status of the alternative resource is self-declared.

15. The method of claim 1 further comprising:
receiving one or more outcomes of the request from the alternative resource.

16. The method of claim 15 further comprising:
sending an instruction to the alternative resource, the instruction providing guidance to the alternative resource in responding to the request, the instruction being based on the request and a resource profile of the alternative resource; and
wherein the one or more outcomes of the request include a feedback associated with instruction, the feedback indicating a usefulness of the instruction in responding to the request.

17. A non-transitory computer-readable medium, a computer program, or a program product, each comprising instructions that, when executed by a processor, cause the processor to perform the method of claim 1.

18. An apparatus comprising at least one processor and at least one machine-readable medium storing instructions which when executed by the at least one processor configure the apparatus to perform the method of claim 1.
